(19) United States
(12) Patent Application Publication
(10) Pub. No.: US 2023/0394181 A1
(43) Pub. Date: Dec. 7, 2023

(54) CO-GENERATION OF COLLISION-FREE SHAPES IN ARBITRARY RELATIVE MOTION

(71) Applicant: Palo Alto Research Center Incorporated, Palo Alto, CA (US)

(72) Inventors: Clinton Morris, San Carlos, CA (US); Amirmassoud Mirzendehdel, Millbrae, CA (US); Morad Behandish, San Mateo, CA (US)

(21) Appl. No.: 17/831,790

(22) Filed: Jun. 3, 2022

(51) Int. Cl. G06F 30/10

(52) U.S. Cl. CPC G06F 30/10; G06F 2119/18

(57) ABSTRACT

The present disclosure provides techniques for automatically generating shapes (e.g., geometric representations) of two or more interacting objects based on arbitrary motions specified for the two or more interacting objects. In an example system. the system receives specifications of motions or movements of two or more objects and the associated design spaces and generates collision-free shapes for the two or more objects while the two or more objects undergo the specified motions. As such, the system solves for unknown or undefined shapes based on desired motion profiles. For example, given respective movement or motion characterizations of two or more objects, such as at least one of a function translation or a function rotation over time in at least one of the three axes in a Euclidean space, topology optimizations may be performed to generate the respective shapes or geometric representations of the two or more objects.

### TECHNICAL FIELD

Implementations of the present disclosure relate to automatic shapes generation in manufacturing.

### BACKGROUND

Mechanical assemblies can exhibit complex relative motions (e.g., an engine may include pistons, a crankshaft, and a number of cam-follower driven valves that move coherently for proper operation). During such complex motions, collisions or interference, such as violation of physical spaces, between moving parts and their surroundings, must be avoided. That is, each moving component must not encounter unwanted interference to avoid physical damage to the mechanical assembly.

To achieve such goals, feasible design spaces are designed for each part's shape. For example, “maximal” collision-free pointsets may be computed using configuration space modeling techniques, such as Minkowski operations and sweep/unsweep. Using such techniques, for a pair of parts undergoing a given relative motion, the geometry of one part (chosen arbitrarily) must be fixed to compute the maximal shape of the other part by an unsweep operation. Making such arbitrary choices in a multi-component assembly can place unnecessary restrictions on the design space, and may not allow for generating or optimizing (e.g., via topology optimization) multiple interactive components (e.g., two or more objects moving simultaneously relative to each other).

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates a block diagram of a collision-free shapes co-generation system for generating geometric representations based on respective motions for two or more objects, in accordance with aspects of the present disclosure.

FIG. 2 illustrates a block diagram of data flow in co-generation of collision-free shapes in arbitrary relative motion, in accordance with aspects of the present disclosure.

FIG. 3 illustrates an example of a cam-follower mechanism, for which shapes of the cam and the follower may be co-generated according to arbitrary motions, in accordance with aspects of the present disclosure.

FIG. 4 illustrates an example formulation of the shapes cogeneration of two objects based on local measures of collision, in accordance with aspects of the present disclosure.

FIG. 5 illustrates an example of generating collision minimizing shapes based on two initial designs, in accordance with aspects of the present disclosure.

FIG. 6 illustrates local collision measures for design domains for two rotating objects, in accordance with aspects of the present disclosure.

FIG. 7 illustrates shape generation results of the rotating objects of FIG. 6, in accordance with aspects of the present disclosure.

FIG. 8 illustrates example shape generation results as a function of a hyper-parameter of the rotating objects of FIG. 6, in accordance with aspects of the present disclosure.

FIG. 9 illustrates examples of local collision measure and unsweep operation on a cam-follower mechanism, in accordance with aspects of the present disclosure.

FIG. 10 illustrates examples of shape co-generation results for maintaining contact during motion of the cam-follower mechanism of FIG. 9, in accordance with aspects of the present disclosure.

FIG. 11 illustrates examples of co-generation of shapes of a three-dimensional (3D) cam-follower mechanism, in accordance with aspects of the present disclosure.

FIG. 12 illustrates an example of co-generation of shapes of a collision-free nut-screw coupling, in accordance with aspects of the present disclosure.

FIG. 13 illustrates a flow diagram of methods of operations, in accordance with aspects of the present disclosure

FIG. 14 illustrates an example computational device for performing operations of topology optimization, in accordance with aspects of the present disclosure.

Like numerals indicate like elements.

### DETAILED DESCRIPTION

The present disclosure provides various techniques for automatically generating shapes (e.g., geometric representations) of two or more interacting objects based on arbitrary motions specified for the two or more interacting objects. In an example system. the system receives specifications of motions or movements of two or more objects and the associated design spaces and generates collision-free shapes for the two or more objects while the two or more objects undergo the specified motions. As such, the system solves for unknown or undefined shapes based on desired motion profiles. The shapes generated may be complicated and take advantage of additive manufacturing techniques. The term “co-generation” or “co-generate” refer to the process in which the shapes for multiple interactive objects are simultaneously generated (e.g., as opposed to generating one shape to fit another).

The present disclosure provides techniques, apparatus, systems, processes, methods, and/or non-transitory computer-readable storage medium for co-generating shapes free from collision or interference given arbitration motions. For example, given respective movement or motion characterizations of two or more objects, such as at least one of a function translation or a function rotation over time in at least one of the three axes in a Euclidean space, topology optimizations may be performed to generate the respective shapes or geometric representations of the two or more objects.

In an example, a processing device may receive a first characterization of motions of a first one of the two or more objects and receive a second characterization of motions of a second one of the two or more objects. The second characterization of motions is associated with the first characterization of motions of the first one of the two or more objects. The processing device may receive a respective design domain for each of the first and the second ones of the two or more objects. The respective design domain may include at least a dimensional constraint for the two or more objects. The processing device may perform, based on the first and the second characterizations of motions of the first and the second ones of the two or more objects and the design domain, topology optimizations for both the first and the second ones of the two or more objects to generate respective geometric representations that enable the first and the second characterizations of motions free from interference between the first and the second ones of the two or more objects. The topology optimizations may include sensitivity fields augmented by gradients and local measures of potential collisions.

In an example, the present disclosure provides a generic method for generating a broad set (or subset) of collision-free objects for given motion conditions. Examples of the present disclosure extends unsweep and allows for co-generation of geometries which change and evolve simultaneously to avoid collision. The techniques herein demonstrate the effectiveness and scalability in both 2D and 3D by generating a variety of collision-free geometric representations. The terms “collision” and “interference” may be used interchangeably herein. Collision or interference occurs when two objects, behaving according to specified motions, experience excessive deformation or stress (e.g., greater than a predefined threshold value). Certain desired surface contact (e.g., two rollers pressing toward each other to provide desired grip or friction, or two gears engaged with each other) is not collision or interference when such contact does not result in excessive deformation or stress.

As discussed below, the disclosed methods are illustrated with examples of automatic generation of freeform cam-follower profiles, gear teeth, and screw threads, starting from colliding blocks of materials, solely from a specification of relative motion and without the use of any feature-informed heuristics. Moreover, the disclosed techniques provide continuous measures of collision. The continuous measures of collision may be incorporated into standard physics-based shape generation, allowing for simultaneous collision-free and physics-informed co-design of mechanical parts for assembly (e.g., verification of interference conditions).

In aspects of the present disclosure, an example automated and scalable method is provided for co-generating geometric representations under parametric motions to satisfy collision avoidance or (equivalently) containment constraints. The example automated method herein may generate a family of “maximal pairs” of collision-free solids (e.g., geometric representations thereof) simultaneously, ensuring persistent contact while avoiding collisions of interference, and using a hyper-parameter to control the relative size of their modified regions. Unlike existing methods that require making arbitrary geometric choices (e.g., fixing one solid and computing the other via unsweep), techniques of the present disclosure avoid premature decisions and unnecessary restrictions that lead to suboptimal solutions. The present disclosure also show that unsweep of each solid against the other is subsumed as a special case of operation at the two extremes of the hyper-parameter spectrum.

Various examples were provided demonstrating aspects of the present disclosure. The disclosed methods may generate pairs of collision-free solids in both 2D and 3D, discretized by immersing them into a pair of Cartesian grids using finite volume (FV) and finite sampling (FS) schemes. By precomputing the sparse pair-wise correlation matrix for a pair of grids in relative motion, the present disclosure demonstrated the scalability of the approach. The most computationally demanding task in the design loop is cast into a pre- and post-multiplication of the correlation matrix with the design variables (e.g., the density arrays for each solid). The results indicate that co-generating is essential, not only for generating a broad family of collision-free solids to enable downstream design flexibility, but also to find well-fitting solids that maintain contact throughout the motion. While collision avoidance is not sufficient to ensure persistent contact, the co-generation approach of the present disclosure is a viable route for designing mechanisms in which contact and complementarity are critical for function, such as cam-follower mechanisms and gear trains. More effective contact or complementarity measures can be developed, using similar measure-theoretic approaches employed for collision measures, to replace the simple mass maximization objective and mass ratio constraint.

Additionally, the formulation of the co-generation procedure in which measures of collision are formulated as locally differentiable fields can be seamlessly integrated into generative design approaches, such as topology optimization (TO). In the context of design for assembly, this could broaden the scope of TO from part-level design to assembly-level design in which parts and components are simultaneously designed for physics-based objectives while ensuring parts are collision free. When co-generating shapes (e.g., of solids) within larger assemblies (e.g., hundreds of parts) one has to deal with combinatorial explosion when attempting to co-design pairs, triplets, and so on, to avoid collision across all parts. This indicates that future work should explore how to avoid the need to compute the collision between all components in an assembly. In the worst case scenario, the initial design domain of each component can be large enough for all parts in an assembly to collide with all others, and the geometric representations are co-generated therein (e.g., in the interfering initial design domains). Various examples are presented below.

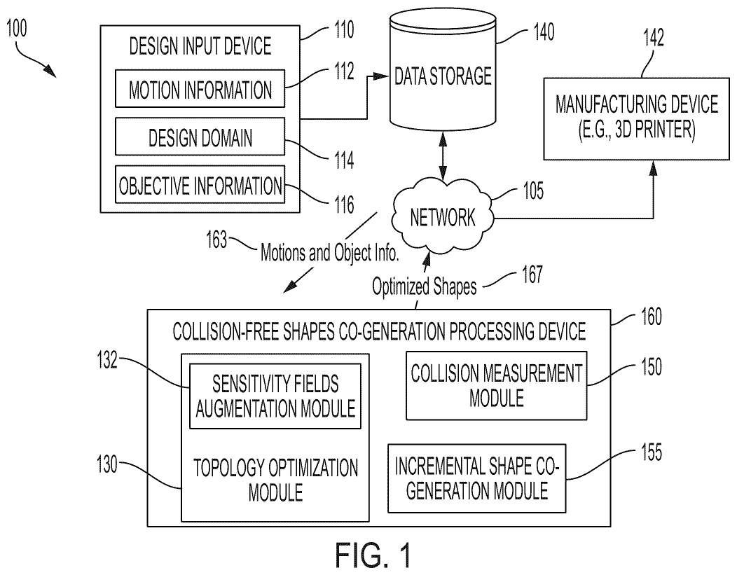

FIG. 1 illustrates a block diagram of a collision-free shapes co-generation system 100 for generating geometric representations based on respective motions for two or more objects, in accordance with aspects of the present disclosure. As shown, the collision-free shapes co-generation system 100 includes a collision-free shapes co-generation processing device 160, which may receive motion and objective information 163 from the data storage 140 via the network 105. The collision-free shapes co-generation processing device 160 may co-generate two or more geometric representations based on the motions and objective information 163 and return corresponding optimized shapes 167 to the data storage 140, as well as sending, via the network 105, the optimized shapes 167 to be manufactured, such as in the manufacturing device 142, which may use additive manufacturing (e.g., 3D printing) technologies or subtractive manufacturing (e.g., cutting) technologies to produce the two or more geometric representations.

The motions and objective information 163 from the data storage 140 may be received from a design input device 110. The design input device 110 may include any computational terminal, such as a standalone computational device that includes individual processing and storage capacities. The design input device 110 may receive various inputs from a user, including motion information 112, design domain 114, and objective information 116.

The motion information 112 may include, for each of two or more interacting objects, a characterization of movement. The characterization of movement may be a function over time. The function may describe any transition in and rotation about a Cartesian axis. The motion information 112 may also include relationships between at least two motions of the two or more interacting objects, such as a phase difference or delays between motions. In some cases, the motion information 112 may include at least one of: a trajectory or a boundary of motions; a velocity of movements along the trajectory or within the boundary; a rate of rotation along the trajectory or within the boundary; or a causal relationship between the first characterization of motions and the second characterization of motions.

The design domain 114 may include boundaries or limits enclosing the respective geometric representation for each of the moving objects. Such boundaries may be identified based on the physical limits of each of the moving object and the surrounding objects (e.g., what the moving object is not interacting with, such as a housing or a boundary limit, size limit, clearance limit, etc.). For objects interacting with each other, the respective design domains 114 may overlap and interfere initially for co-generating the collision-free results. In some cases, the design domain 114 includes at least one of: a parameter of a material aspect of the first or the second one of the one or more objects for determining deformation in the potential collisions; or a parameter of a production aspect of the first or the second one of the one or more objects for determining manufacturability of the first or the second one of the one or more objects.

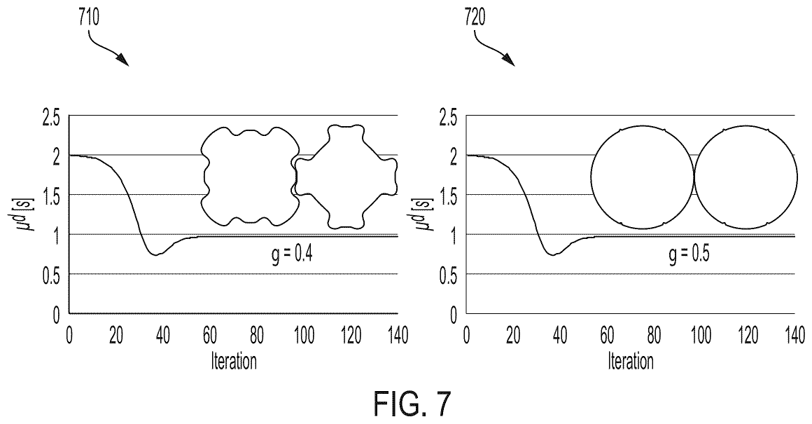

The objective information 116 may include constraints or criteria for determining or selecting results that satisfy the motion requirements 112 within the design domain 114. For example, the objective information may include load capacity, material applicability, costs, and different aspects of performance (see examples corresponding to FIGS. 7-11).

In some cases, the objective information 116 may include specific materials or associated manufacturing techniques for producing the geometric representations to be generated. For example, certain shapes may be available in additive manufacturing (AM) while some other shapes may be suited for subtractive manufacturing (SM), both of which may affect shape and strength availabilities. In AM in general, layers of materials may be added along a direction to form a 3D shape. The strength of the produced shape may thus depend on the bonding between the layers. In SM, however, a block of material is cut (e.g., by milling, turning, etc.) down to the desired shape. The strength of the produced shape may thus depend on the original material strength. Both AM and SM produced parts may use post-processing, such as heat treatment, to further alter the strength of the produced parts.

Regarding AM, any material that may solidify into a controlled pattern may form each of the added layers, such as, for example, powder materials to be sintered at high temperatures, extrudable materials to be extruded and solidify, and photosensitive materials to be solidified from liquid by light. Specifically, powder materials may include any pulverized materials, such as metal powders and powders of various thermoplastics. When locally heated, by a high power laser dot, for example, the powder materials melt and connect into a solitary piece. By controlling manufacturing parameters, including power output, how fast the laser dot (or another heat source) is traveling, how big (or small) the laser dot is used, the size and density of the powder materials, the melting temperature, and other production parameters, a physical copy of the model can be produced. Selective laser sintering (SLS), selective laser melting (SLM), and laser powder bed fusion (LPBF) are examples of manufacturing techniques that use powder materials.

Extrudable materials may include various thermoplastic materials as well as edible materials such as sugar or ice cream, or materials such as sand or glass. Example thermal plastic materials may include acrylonitrile butadiene styrene (ABS), polylactic acid (PLA), polyethylene terephthalate glycol (PTEG), nylon, thermoplastic polyurethane (TPU), polycarbonate (PC), and any combination thereof. Fused deposition modeling (FDM) is an example AM technique applicable to use extrudable materials in AM processes. Extrudable materials may also include materials that solidify by chemical reactions, such as concrete, two-part epoxy, or the like.

During printing of the extrudable materials, a controlled portion of the extrudable materials is extruded and deposited onto a layer below (or the build plate when printing the first layer). The deposited portion is quickly cooled down to solidify, either by conducting the heat away through the layer below or transferring away by cool air created to surround the extrusion. Or, in case of curing or solidifying by chemical reactions, the extruded materials may solidify in an expected reaction time. By controlling production parameters, such as the extrusion temperature, the cooling rate (or the solidifying rate), the extrusion rate, and other constraints (e.g., the width of the extrusion nozzle), parts of different materials and different strengths can be printed.

Photosensitive materials may include curable resin materials reactive to ultra-violet radiations at various wavelength ranges (e.g., 390-405 nm). During printing, each layer of photosensitive materials is exposed, either globally or locally, to a curing light source to transform from liquid to solid. In some examples, such as stereolithography (SLA) 3D printing or liquid crystal display (LCD) 3D printing, a tank or bath of the photosensitive materials may be disposed between a light source and a build platform. The light source may be a moving laser dot (e.g., in SLA) or a collimated beam filtered by an LCD. The initial layer may be created by having the build platform positioned adjacent to a transparent and flexible medium to produce a thin layer of the photosensitive materials in the liquid phase. The movement of the laser dot and the filtering pattern of the LCD creates the pattern for each layer.

Upon the initial layer solidifies, the build platform and the cured layer are moved away from the medium to allow the next layer of photosensitive materials in liquid phase to enter the gap between the platform and the medium. Layer by layer, the build platform moves away from the medium (and the light source) to form the model. In some examples, such as in “Polyjet” 3D printing, the photosensitive materials may be disposed directly by jetting (similar to jetting ink by inkjet printers) onto the previous layer or a build surface and then cured by a light source.

In some examples, a print head may extrude thick or viscous photosensitive materials that are cured by a light source carried by the print head. When the aforementioned techniques are used, the design domain 114 may include various aspects of exposure (e.g., light power, rate of transmission, exposure time, etc.), pattern creation (e.g., laser dot size, LCD resolution, jetting resolution, etc.), and other system parameters (e.g., layer height, material properties, etc.).

During operation, the design input device 110 may receive the motion information 112, the design domain 114, and the objective information 116. The design input device 110 may then provide the information (collectively referred to as the motions and objective information 163) to the data storage 140 connected to the network 105. The network 105 may, upon demand or request by a user, provide the motions and objective information 163 to the processing device 160. When the processing device 160 completes co-generating the optimized shapes 167, the processing device 160 transfers the optimized shapes 167 to the data storage 140 to be accessible by the manufacturing device 142.

As shown, the collision-free shapes co-generation processing device 160 may include a topology optimization module 130, a collision measurement module 150, and an incremental shape co-generation module 155. The topology optimization module 130 may further include a sensitivity fields augmentation module 132. These modules operate to provide a general formulation and computational framework for co-generating maximal collision-free shapes in arbitrary relative motion. In particular, the techniques herein, as performed by the collision-free shapes co-generation processing device 160, expand the unsweep operation and the underlying notion of maximality (for a partial ordering of sets) to two or more of solids, to more broadly explore the space of collision-free designs. The techniques herein may measure the collision of solids in relative motion both locally and globally to use as a differentiable violation measure for gradient-descent optimization.

According to aspects of the present disclosure, the violation measure may be used to formulate an iterative and incremental co-generation procedure for a broad subset of maximal pairs of collision-free solids. In addition, the techniques disclosed herein may be scaled to efficiently co-generate a variety of nontrivial collision-free solids with persistent contact in both two-dimensional (2D) and three-dimensional (3D) models.

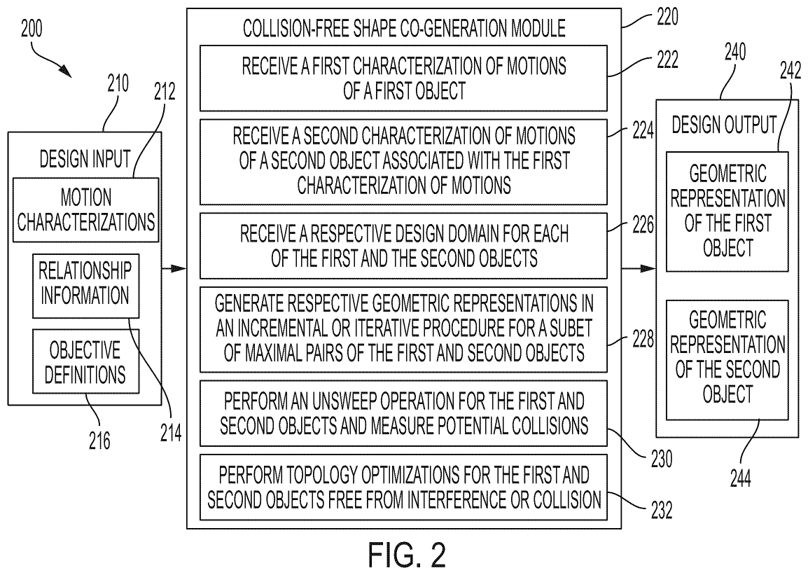

Finally, the techniques herein may easily be integrated with other constraints in gradient-descent optimization to extend beyond geometric reasoning. In some cases, the present disclosure also computes the collision measure efficiently by linear-algebraic operations, involving a pre-computed pairwise correlation matrix that depends on the motion, pre- and post-multiplied by arrays of design variables, all of which can be parallelized on multi-core and/or multi-thread central processing units (CPU) as well as graphical processing units (GPU). Details operations of the collision-free shapes co-generation processing device 160 are further discussed in view of FIGS. 2-12.

Although the design input device 110 and the collision-free shapes co-generation processing device 160 are illustrated as two separate devices, in some cases, the design input device 110 and the collision-free shapes co-generation processing device 160 may be included in a same computational system (or two modules on a common computational platform). In some cases, the design input device 110 may have sufficient computational power to behave as the collision-free shapes co-generation processing device 160, or the collision-free shapes co-generation processing device 160 may include one or more user interfaces to receive direct input of modeling and production parameters therein.

In some cases, the design input device 110 may be a consumer terminal (e.g., a personal computer, a smart phone, etc.) that enables a user to upload designs and relevant information to the data storage 140. The collision-free shapes co-generation processing device 160 may behave as a server performing requested services to modify or improve the shape and production information in the data storage 140, via the network 105. The data storage 140 may store production information separate from the design input device 110 (e.g., from the primary manufacturing device 142). The systems, techniques, and methods disclosed herein may therefore be applicable without a fixed terminal for the design input device 110, and rather, a flexible web-based service that connects user data, processing devices, and manufacturing devices in one production optimization environment.

As to be described with various examples below, in the present disclosure, the collision-free shapes co-generation system 100 allows for automatic shape co-generation of objects given arbitrary relative motions to avoid collision or other (equivalent) containment constraints are disclosed. In some cases, the constraints may include various design criteria involving interactions of shapes and motions. To incorporate such constraints into gradient-based optimization, according to aspects of the present disclosure, violations of the containment constraints are locally evaluable and differentiable with respect to design variables (e.g., small geometric or topological changes), to penalize the objective functions. Additionally, collision is a pairwise relation, presenting additional challenges when multiple moving parts are to be designed simultaneously. Changes to one part will potentially introduce or eliminate collisions with the others, necessitating a co-design workflow in which the parts are shaped simultaneously, evolution of one part directly informing those of the others in the assembly.

Aspects of the present disclosure provide a framework to develop such workflows to design families of parts in which collision avoidance constraints can be simultaneously satisfied and seamlessly integrated with other (e.g., performance and manufacturing) constraints. More specifically, aspects of the present disclosure provide an example procedure to generate members of a family of “maximal pairs” of collision-free parts or objects. Herein, the terms objects, parts, shapes, forms, designs, geometries, and geometric representations may be understood interchangeably as a geometric representations of objects and the like.

Existing methods do not allow for co-generation of objects based on interactive and arbitrary motions. There are at least two challenges, formulated in a set-theoretic language, in a design framework. First, they require full knowledge of all but one of the shapes and motions on which they apply—for instance, sweep/unsweep map a given shape and a given motion to a maximal shape, while homogeneous Minkowski products/quotients map a given pair of shapes to a maximal motion, avoiding collisions. Second, these set-theoretic operations do not interoperate well with other (e.g., performance and manufacturing) constraints, commonly expressed using analytic inequalities. Unlike the latter, the former does not measure violation of collision constraints, which is critical for navigating tradeoffs with other constraints. Measure-theoretic generalizations of such operations based on convolution algebras have led to a path forward by formulating violations of collision constraints as locally evaluable and differentiable measures and integrating them with other constraints via Lagrange multipliers. Therefore, existing practice has been limited to single part design or shape generation.

In contrast, techniques disclosed herein do not require either part's shape to be fixed upfront and can generate families of maximal collision-free designs, using local and global measures that can be integrated with other constraints and differentiated for gradient-descent optimization. The present disclosure provides an incremental co-generation procedure that subsumes one-way unsweeps of either part, against the initial design of the other part's complement, as extreme cases of the family of maximal pairs. Aspects of the present disclosure provide a computational algorithm to compute collision measures using a voxelization of the moving domains. An example formal set-theoretic groundwork not tied to a specific representation scheme and can be discretized in many different ways is also disclosed. Moreover, the present disclosure uses gradients and local measures of the collision measures to augment the TO sensitivity fields, enabling further scalability. Importantly, techniques disclosed herein generate families of maximal shapes as opposed to a single arbitrary pair obtained using rule-based heuristics.

FIG. 2 illustrates a block diagram 200 of data flow in co-generation of collision-free shapes in arbitrary relative motion, in accordance with aspects of the present disclosure. As shown, design input 210 is provided to the collision-free shape co-generation module 220, which generates the design output 240. The design input 210 may include motion characterizations 212 indicating respective motions of two or more interactive objects, relationship information 214 specifying the interaction between the two or more objects, and one or more objective definitions 216. The relationship information 214 may include a timing difference between two motion profiles of two of the two or more objects. The objective definitions 216 may include production cost, target cost reduction, production time limits, production schedule, strength, and other goal related criteria.

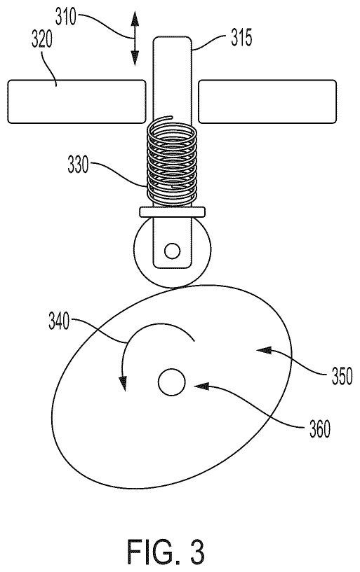

Upon receiving the design input 210, the collision-free shape co-generation module 220 may, at 222, receive a first characterization of motions of a first object, such as from the motion characterizations 212. An example of a first characterization of motions is shown in FIG. 3. Turning briefly to FIG. 3, which shows a cam-follower mechanism example 300, a first motion 310 may include a one degree-of-freedom (DOF) translation characterized by a change of vertical position over time (e.g., a cyclic up-and-down motion). The first motion 310 may be characterized independently as an input.

At 224, the collision-free shape co-generation module 220 receives a second characterization of motions of a second object. In the cam-follower mechanism example 300 of FIG. 3, a second motion 340 may include a one DOF rotation characterized by a change of angular position over time (e.g., a cyclic rotation at various angular speeds over time). The second characterization of motions of the second object (e.g., the cam 350) may be associated with the first characterization of motions of the first object (e.g., the follower 315) in that the second motion 340 causes the first motion 310 (e.g., the cyclic up-and-down motion and the cyclic rotation motion share a common periodicity). In some cases, the association or relationship between the second motion and the first motion may be specified by the relationship information 214.

At 226, the collision-free shape co-generation module 220 may receive a respective design domain for each of the first and the second objects. For example, in FIG. 3, the cam 350 may be assigned with a design domain (e.g., bounding dimensions) for generating an outer profile that produces the first motion 310 with the follower 315. Similarly, the follower 315 may be assigned with a design domain for boundaries of the up-and-down motion, as well as size or shape limits for the roller 335 (an intermediate part for reducing friction and not necessarily round). The design domains of the first and second objects may start at an interfering or overlapping condition to allow for co-generation of the first and the second objects.

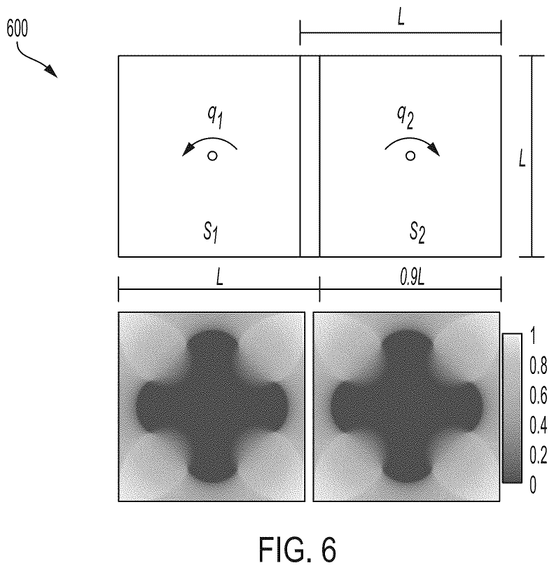

At 228, the collision-free shape co-generation module 220 may generate respective geometric representations in an incremental or iterative procedure for a subset of maximal pairs of the first and second objects. For example, the initial geometric representations may be shapes corresponding to the respective design domains, which may overlap (e.g., potential collisions to be measured in the coming procedures). An illustrative example is provided in FIG. 6.

At 230, the collision-free shape co-generation module 220 may perform an unsweep operation for both the first and the second objects and measure the potential collisions. Based on the measurement, at 232, the collision-free shape co-generation module 220 may perform topology optimizations for the first and the second objects so that the respective geometric representations of the first and second objects are free from interference or collision when performing the first and the second motions.

The design output 240 may include the co-generated results for the geometric representation of the first object 242 and the geometric representation of the second object 244. Illustrative examples are shown in FIGS. 7-12.

FIG. 3 illustrates an example of a cam-follower mechanism 300, for which shapes of the cam 350 (rotating around the axis 360) and the follower 315 (may include the roller 335) may be co-generated according to arbitrary motions, in accordance with aspects of the present disclosure. As mentioned above, target motions 310 of the follower 315 and rotation 340 of the cam 350 may respectively be given. In addition to the motion 340, the motion 310 may be produced based on the constraint 320 (which limits the DOF of the follower 315) and the constraint 330 (which provides for the constant contact between the follower 315 and the cam 350. According to aspects of the present disclosure, based on the defined motions 310 and 340, the respective geometric representations of the follower 315 and the cam 350, such as the outer profiles of the cam 350 and the roller 335, can be co-generated to produce a collision-free mechanism 300.

For example, kinematic design of mechanical parts and assemblies under prescribed motions can be formulated as computing “maximal” pointsets that satisfy collision avoidance or (equivalently) containment constraints. The maximality is defined in the partial ordering of pointsets with respect to containment. Such maximal shapes prune the design space to a feasible subspace, defined by the powerset of the maximal pointset, for subsequent design space exploration to satisfy various performance and manufacturing criteria (e.g. via topology optimization).

To illustrate, let S⊂ [symbol] ^{d} stand for a d dimensional solid or ‘r-set’, defined as a compact (bounded and closed) regular semi-analytic pointset in the Euclidean d space [symbol] ^{d}. Let M⊂SE(d) be a motion, e.g., a parametrized collection of rigid configurations or ‘poses’ (combined rotations and translations) that a d dimensional pointset can assume. For computational purposes, the solids are commonly represented by boundary or volumetric representations (e.g., NURBS, CSG, surface/volume mesh, voxels, or sampled point clouds), while motions are typically represented by sampled or parametrized homogeneous matrices, dual quaternions, etc.

The first class of problems can be formulated and solved using the sweep and unsweep operations. The sweep of a given solid S under a given motion M is another pointset sweep (M, S)⊂ [symbol] ^{d}, which is a superset of S collecting all points that are included in the displaced shape τS for at least one configurations τ∈M:

### Explicit Definition (by an Indexed Union):

$$sweep ( M , S ) {=}^{△} {⋃}_{τ ∈ M} τ S$$

### Implicit Definition (by a Membership Test):

$$\begin{matrix}sweep ( M , S ) {=}^{△} \{ x ∈ {ℝ}^{d} \vert ∃ τ ∈ M : x ∈ τ S \} \\ {=}^{△} \{ x ∈ {ℝ}^{d} \vert {M}^{- 1} x ⋂ S \neq ∅ \}\end{matrix}$$

where Mx≙{τx|τ∈M}“and” τS≙{τx|x∈S},
where τx∈ [symbol] ^{d} denotes a displaced point.

Note that the membership of a query point x∈ [symbol] ^{d} in the sweep is tested by applying the inverse motion to the query point and checking whether the resulting trajectory passes through the given shape.

On the other hand, the unsweep of a given solid S undergoing a given motion M is another pointset unsweep (M, S)⊂ [symbol] ^{d}, defined by the subset of S including all points that that remain included in the displaced shape τS for all configurations τ∈M:

### Explicit Definition (by an Indexed Intersection):

$$unsweep ( M , S ) {=}^{△} {⋃}_{τ ∈ {M}^{- 1}} τ S .$$

### Implicit Definition (by a Membership Test):

$$\begin{matrix}unsweep ( M , S ) {=}^{Δ} \{ x ∈ {ℝ}^{d} \vert ∀ τ ∈ M : x ∈ τ S \} \\ = \{ x ∈ {ℝ}^{d} \vert Mx ⋂ \overline{S} \neq ∅ \}\end{matrix}$$

where Ŝ≙( [symbol] ^{d}−S) (is the set complement of S.

Note that the membership of a query point x∈ [symbol] ^{d} in the upsweep is tested by applying the forward motion to the query point and checking whether the resulting trajectory passes through the given shape.

To see how sweep and unsweep can be used in practical design problems, consider a pair of solids S₁, S₂⊂ [symbol] ^{d} moving under one-parametric motions M₁, M₂⊂ [symbol] ^{d}. The solids can be parts in a single degree-of-freedom (DOF) mechanism, e.g., any pair of links in a four-bar linkage, a cam and a follower, a pair of gears, a latch and a pin, etc. The relative motion (of S₂ as observed from a frame attached to S₁) is M≙M₁⁻¹M₂. If the present disclosure fix the shape of solid S₁, the maximal pointset that does not collide with S₁ (e.g., is contained within S̅₁) is:

S*₂≙s̅w̅e̅e̅p̅(̅M̅⁻̅¹̅,̅S̅₁̅)̅=unsweep(M,S̅₁).

The maximality implies that every other solid that satisfies the no-collision constraint will be a subset of the maximal pointset (e.g., (MS₂∩S₁=0 iff S₂⊆S*₂).

Let us assume the 1-DOF motion can be parametrized as M={τ(t)|0≤t≤1}. For the 1 DOF mechanisms exemplified above, t∈[0, 1] can be thought of as normalized time—or any parameter monotonically changing with time—over the mechanism's motion cycle. For example, in the cam-follower mechanism 300 of FIG. 3, the goal is to design the shape of a latch S_{L}, rotating around a pivot by a given trajectory M_{L} with respect to a common frame of reference. There are two constraints:

Constraint 1: Let S_{B} represent a bounding region that the follower 315 must not exit certain boundary to avoid collision with surrounding objects that are stationary (hence MB is identity).

Constraint 2: Let S_{P} represent the cam 350 of given shape, attached to the common frame of reference, thus moving along a given trajectory M_{P}. The follower 315 must avoid collision while maintaining contact with the cam 350, as it moves with a relative motion M_{P}⁻¹M_{L}.

The design space for S_{L} is thus restricted (by the conjunction of these constraints) to subsets of

S*_{L}:=unsweep(M_{L},S_{L})∩unsweep(M−1ML,SP).

Despite its generality (for arbitrarily complex shapes and motions) and rigor, this approach in current practice has three major limitations, which are to be overcome by the techniques provided in the present disclosure. The limitations include:

First, using unsweep requires pre-defining one of the two shapes in relative motion to obtain a maximal shape for the other one. This requirement may be fine for design problems with clear choices for the shapes of certain components or spatial regions because of non-negotiable conditions (e.g., a bounding box) or simple profiles (e.g., the cam 350 of FIG. 3 and cylindrical/flat followers). However, in problems where both shapes in relative motion are to be designed simultaneously (e.g., the cam/follower system), the arbitrary choice of either shape significantly limits the design freedom and requires trial-and-error iterations over a theoretically uncountable—and computationally exponential—number of possibilities. Aspects of the present disclosure provide techniques to define an analytic generalization of unsweep to enable co-design of both shapes, coming up with families of “maximal pairs” of points that satisfy the no-collision or (equivalently) containment constraints.

Second, the maximal pointsets that satisfy these constraints come with no guarantees for effective contact, shape complementary, force/torque transmission, etc., whose quantification for arbitrary shapes is nontrivial. For example, consider two parts in a relative screw motion, each to be selected as a subset of the bounding boxes. If one of the parts is shaped as a cylindrical hole or a threaded nut, the maximal shape for the other part will be computed by an unsweep as a matching cylindrical peg or a threaded bolt, respectively. The contact and complementary is perfect in this case, because the screw motions form a symmetry subgroup of SE(3) and the first part's shape (the nut) was carefully selected such that this particular screw motion of the same pitch is it's symmetry; hence unsweep generates a matching shape (the bolt) that, not only avoids collision with the nut, but is also a perfect complement of it and remains as such throughout the motion. However, if a slightly different shape for the first part is picked, such as a half-cylindrical hole or a nut of a different pitch, the unsweep would generate a maximal shape that, despite avoiding collision, offers poor contact and complementarity. This example illustrates why co-design or co-generation is an improved approach as disclosed herein, where both shapes are generated (e.g., by initial selection or definition) and refined (e.g., by topology optimization) simultaneously.

The third limitation is that set-theoretic operations such as unsweep, used to express kinematic constraints, do not interoperate well with analytic constraints such as global or local inequalities in terms of field variables, used to express physics-based constraints (e.g., stiffness or strength). As a result, concurrently satisfying kinematic and physical constraints is challenging. In some cases, set-theoretic operations may be translated with measure-theoretic parallels, e.g., by replacing Boolean and morphological operations of pointsets with pointwise logical operations and convolutions of their indicator functions, respectively. The later extend the former by not only providing binary membership tests for set operations, but also continuous and differentiable membership “grades” that measure violations of constraints and can be penalized to sensitivity fields for topology optimization. By comparison, the present disclosure provides a measure-theoretic extension of unsweep that defines a distributed field measuring pointwise collision on both objects in relative motion, and a systematic approach to incrementally reduce them by adding/removing points from both pointsets.

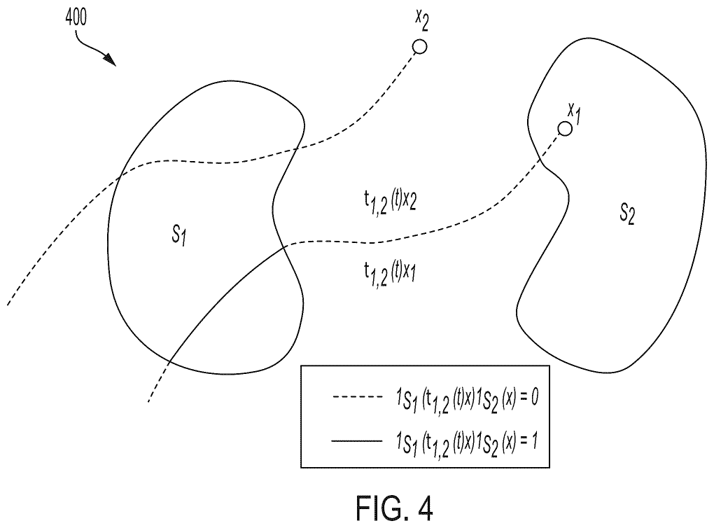

FIG. 4 illustrates an example formulation 400 of the shapes cogeneration of two objects based on local measures of collision, in accordance with aspects of the present disclosure. FIG. 4 illustrates a formal modeling framework to define maximal collision-free pairs of solids under given one-parametric motions, and a discretization scheme to make them computable. In particular, the present disclosure shows that the computations can be separated into precomputing a motion-dependent and shape-independent correlation matrix offline, while collision measures for specific shapes can be computed online (e.g., during iterative design) via fast matrix multiplication.

To illustrate, two design domains are considered: Ω₁, Ω₂⊆ [symbol] ^{d} for the two solid the present disclosure aim to co-design (d=2, 3). The formulation may begin from two given initial designs S₁⊆Ω₁ and S₂⊆Ω₂ representing the shapes of the two solids at rest (e.g., before applying any motion). Let M₁, M₂∈SE(d) represent the motions that these solids experience with respect to a common frame of reference.

M₁≙{τ₁(t)|0≤τ≤1},

M₂≙{τ₂(t)|0≤τ≤1},

where τ₁, τ₂: [0, 1]→SE(d) are continuously time-variant configurations, and can be represented by homogeneous matrices, dual quaternions, etc. The displaced solids at any given time t∈[0, 1] are:

S₁(t)≙τ₁(t)S₁={τ₁(t)x|x∈S₁},

S₂(t)≙τ₂(t)S₂={T₂(t)x|x∈S₂}.

Without loss of generality, the present disclosure assume τ₁(0)=τ₂(0) to be identity, so S₁(0)=S₁ and S₂(0)=S₂, as intended.

To formulate collision measures, it is more convenient to represent the two pointsets implicitly via binary membership tests, also called indicator or characteristic functions 1_{S1}, 1_{S2}: [symbol] ³→{0,1}, defined generally by:

$${1}_{S} ( x ) {=}^{Δ} \{ \begin{matrix}1 & if x ∈ S \\ 0 & otherwise\end{matrix}$$

The indicator functions are contra-variant with rigid transformations, e.g., 1τ_{S}(x)=1_{S}(τ⁻¹x). This means that a membership query for a given point against the displaced solid can be computed by displacing the query point along the inverse trajectory and testing its membership against the stationary solid.

Let M=M₁⁻¹M₂ stand for the relative motion of S₂ as observed from a frame of reference attached to S₁, noting that by kinematic inversion, M⁻¹=M₂⁻¹M₁ would represent the relative motion of S₁ as observed from a frame of reference attached to S₂.

Let M_{1,2} (resp. M_{2,1}) represent the relative motions of S₂ (resp. S₁) as observed from a moving frame of reference attached to S₁ (resp. S₂):

M_{1,2}≙M₁⁻¹M₂={τ_{1,2}(t)|0≤t≤1},

M_{2,1}≙M₂⁻¹M₁={τ_{2,1}(t)|0≤t≤1};

where τ_{1,2}(t)=τ₁⁻¹(t)τ₂(t) and τ_{1,2}(t)=τ₁⁻¹(t)τ₂(t). Note also that τ_{1,2}(t)=τ_{2,1}⁻¹(t) hence M_{1,2}(t)=M_{2,1}⁻¹(t).

The displaced solids at any given time t∈[0, 1] in the relative frames are:

S_{1,2}(t)≙τ_{2,1}(t)S₁={τ_{2,1}(t)x|x∈S₁}

S_{2,1}(t)≙τ_{1,2}(t)S₂={τ_{1,2}(t)x|x∈S₂}

To quantify the contribution of every point x∈ [symbol] ³ attached to S₁ (resp. S₂) to its collision with S₂ (resp. S₁), the present disclosure can measure the duration of its trajectory that collides with S₂ (resp. S₁):

f_{S}_{₁}(x)≙∫₀¹1_{S}_{_{2,1}}₍ₜ₎(x)dt=∫₀¹1_{S}_{₂}(τ_{2,1}x)dt

f_{S}_{₂}(x)≙∫₀¹1_{S}_{_{1,2}}₍ₜ₎(x)dt=∫₀¹1_{S}_{₁}(τ_{1,2}x)dt

as illustrated in FIG. 4. To eliminate the contribution of the points that are outside each shape, the present disclosure can multiply by the indicator functions of each shape:

[symbol]

_{S}_{₁}(x)≙∫₀¹1_{S}_{₂}(τ_{2,1}x)1_{S}_{₁}(x)dt

[symbol]

_{S}_{₂}(x)≙∫₀¹1_{S}_{₁}(τ_{1,2}x)1_{S}_{₂}(x)dt

which resemble convolutions (need not be, however, because these motions do not necessarily form subgroups; analysis herein applies anyways), generalized from the Euclidean space to motions M_{1,2}, M_{2,1}∈SE(d).

Lemma 1. The two functions above are implicit representations of the following unsweeps as their 0-superlevel sets (up to regularization), e.g., the following statement is true “almost everywhere.” That is, it can be untrue over regions of d−1 or lower dimensions, which disappear upon topological regularization.

x∈unsweep (M_{1,2},S̅₂)∩Ω₁ [symbol] _{S}_{₁}(x)=0,

x∈unsweep (M_{2,1},S̅₁)∩Ω₂ [symbol] _{S}_{₂}(x)=0,

The idea is that by definition, points in a given unsweep (M,S) are defined by containment in S̅ (e.g., no intersection with S) under the motion M. Asserting zero collision measures is a similar criteria, however, the d-integrals cannot capture d-1 and lower-dimensional interference (e.g., contract), hence the equivalence is almost everywhere.

To derive global measures (a single value for each solid) from the above local measures, the present disclosure can integrate them over the respective solids:

g_{S}_{₁}≙∫_{S}_{₁}f_{S}_{₁}(x)dμ^{d}[x]=∫_{Ω}_{₁} [symbol] _{S}_{₁}(x)dμ^{d}[x]

g_{S}_{₂}≙∫_{S}_{₁}f_{S}_{₂}(x)dμ^{d}[x]=∫_{Ω}_{₂} [symbol] _{S}_{₁}(x)dμ^{d}[x]

The goal of collision-free co-design is to find a “maximal pair” of solids S₁⊆Ω₁ and S₂⊆Ω₂ in a sense that the present disclosure shall define precisely below, such that g_{S2}=gₛ₂=0, which is true iff for all x∈ [symbol] ^{d}, f̅_{2̅}(x)=0.

Definition 1. A pair of solids (S₁, S₂) are called collision-free under the relative motion M_{1,2}=M_{2,1}⁻¹ if:

μ^{d+1}[S₁∩M_{1,2}S₂]=μ^{d+1}[M_{2,1}S₁∩S₂]=0

Lemma 2. A pair of solids (S₁, S₂) are collision-free iff g_{S2}=0 which is equivalent to g_{S2}=0.

The above collision criteria imply interference over a d-dimensional region—while contact over lower (d−1 and below) dimensional regions is allowed-over a 1-measurable period of time. Substituting the local measures into the global measures and swapping the space and time integrals yield:

g_{S}_{₁}=∫₀¹∫_{Ω}_{₁}1_{S}_{_{2,1}}₍ₜ₎(x)1_{S}_{₁}(x)dμ^{d}[x]dt

g_{S}_{₂}=∫₀¹∫_{Ω}_{₂}1_{S}_{_{1,2}}₍ₜ₎(x)1_{S}_{₂}(x)dμ^{d}[x]dt

At a given snapshot t∈[0.1], the inner integrals are nonzero iff μ^{d}[S₁(t)∩S₂(t)]=0 which, by changing the fram of reference to those attached to each solid, is equivalent to μ^{d}[S₁∩S_{2,1}(t)]=0 abd μ^{d}[S_{1,2}(t)∩S₂]=0. The outer integrals are nonzero if such a nonzero d-measurable interference persists for a 1-measurable period of time.

Definition 2. A pair of collision-free solids (S*₁, S*₂) under the relative motion M_{1,2}=M_{2,1}⁻¹ is “maximal” if any d-measurable growth of either solid, while keeping the other solid unchanged, makes them no longer collision-free under the same motion. More precisely, for every other pair of solids (S₁, S₂):

if S*₁⊂S₁ then (S₁,S*₂) cannot be collision-free; and

if S*₂⊂S₂ then (S*₁,S₂) cannot be collision-free.

The maximal pairs can be more formally defined by a imposing a partial order relation [symbol] over the space of all collision-free pairs, where (S₁, S₂) [symbol] (S′₁, S′₂) iff S₁⊆S′₁ and S₂=S′₂ or S₁=S′₁ and S₂⊆S′₂. A pair (S*₁, S*₂) is maximal if (S*₁, S*₂) [symbol] (S′₁, S′₂) implies (S*₁, S*₂)=(S′₁, S′₂).

Notice that for a maximal pair of collision-free solids (S*₁, S*₂), if one solid is grown by the slightest bit, the only way to keep the pair collision-free for the same motion scenario is to shrink the other solid. This observation provides us with an incremental shape modification strategy to traverse a family of maximal pairs, akin to walking along a Pareto front of maximality. If the present disclosure picture the design space of all pairs of solids within the domains Ω₁, Ω₂⊆ [symbol] ^{d}, the maximal front is a higher-dimensional manifold that bounds the feasible design subspace.

Corollary 1. Given a pair of “initial designs” S₁⊆Ω₁ and S₂⊆Ω₂ that collide under one-parametric motions M₁, M₂⊆SE(3), the following two pairs of maximally collision-free can be constructed via unsweep:

(S₁,S*₂), where S*₂≙unsweep(M_{1,2},S̅₁)∩Ω₂,

(S*₁, S₂), where S*₁≙unsweep(M_{2,1},S̅²)∩Ω₁,

Note that these are extreme cases:
S*₂ is the maximal solid that does not collide with S₁, assuming the shape of S₁ is fixed.
S*₁ is the maximal solid that does not collide with S₂, assuming the shape of S₂ is fixed.

However, there are uncountably many other pairs (S′₁, S′₂ in between the two extreme cases, if the present disclosure allow both shapes to change. All of them can be captured by simultaneously satisfying g_{S′}_{₁}=g_{S′}_{₂}=0.

The next operation is how the present disclosure may effectively parameterize the family of maximal collision-free pairs (S′₁, S′₂), e.g., how do the present disclosure pick a hyper-parameter γ∈[0,1] such that:

(S′₁,S′₂)γ|_{γ:=0}=(S₁,S*₂),

(S′₁,S′₂)γ|_{γ:=1}=(S*₁,S₂),

while (S′₁, S′₂)γ for γ∈[0,1] produces other maximal pairs in between. Note that this does not mean the uncountable family of all maximal pairs can be parameterized with a single (or a number of) parameters—in fact, it cannot. Aspects of the present disclosure provide techniques to capture some subset of the family with a meaningful hyper-parameter that serves as a “knob” to navigate tradeoffs for design space exploration. An optimization-based approach is provided below.

The above formulation is representation-agnostic and can be used with a variety of different representation schemes (e.g., B-reps, mesh, and voxels), as long as they support computation of d-integrals—and if they do not, one can approximate d-integrals by sampling the solids using quadrature rules, as long as the representation schemes support basic membership classification queries. Here, the present disclosure provides examples using the simplest approach to illustrate the practicality of formulation methods disclosed herein.

To enable finite representation of solids and digital computation of collision measures, let us approximate the indicator function using a finite linear combination:

$${ρ}_{S} ( x ) = {\sum }_{i = 1}^{n} {ρ}_{S , i} {ϕ}_{i} ( x ) , {ρ}_{i} ∈ [ 0 , ∞ ) , {ϕ}_{S , i} : {ℝ}^{d} \to ℝ$$

where ϕ₁(x) are local basis functions associated with a spatial tessellation and p_{S,i}≥0 are the corresponding density values for i=1, 2, . . . , n. To approximately compute the integrals in (21) and (22), the present disclosure considers an asymmetric discretization strategy in which the stationary solid (e.g., the one to which the frame of reference is attached) is discretized via a finite volume (FV) scheme, while the moving solid (e.g., the one whose motion is observed) is discretized via a finite sample (FS) scheme.

For both schemes, let us immerse the solid in a uniform Cartesian grid of edge length ϵ>0, which is small enough to resolve the minimum features of the solid. Let xᵢ∈ [symbol] ^{d} be the coordinates of the i^{th} vertex (e.g., 0-cell) on the grid. Let Cᵢ⊂ [symbol] ^{d} stand for the dual d-cell (e.g., square pixels in 2D and cubic voxels in 3D):

Cᵢ≙{xᵢ+x|x∈C},C≙[−∈/2,+∈/2]^{d}

To capture the d-integral quantities accurately, let us associate to the i^{th} grid vertex/cell the d-measure of the solid confined to Cᵢ, normalized by μ^{d}[Cᵢ]=∈^{d}:

$${ρ}_{S , i} {=}^{Δ} \frac{{μ}^{d} [ S ⋂ {C}_{i} ]}{{μ}^{d} [ {C}_{i} ]} = \frac{1}{{ϵ}^{d}} {\int }_{{C}_{i}} {1}_{S} ( x ) d {μ}^{d} [ x ]$$

For the FV scheme, the basis functions are selected as unit pulse functions, e.g., indicator functions of Cᵢ:

∅ᵢ^{FV}(x)≙1_{C}_{ᵢ}(x)=1_{C}(x−xᵢ).

Using these basis functions in the discrete formula above gives a piecewise-constant approximation of the indicator function over the dual grid. For the FS scheme, on the other hand, the basis functions are selected as impulse functions of intensity ∈^{d}, e.g., shifted Dirac delta functions weighted by the d-measure of the cells they “lump” into their center points:

$${∅}_{i}^{FS} ( x ) {=}^{Δ} {∈}^{d} {δ}^{d} ( x - {x}_{i} ) ≅ {lim}_{σ \to {0}^{+}} \frac{{∈}^{d}}{{σ}^{d}} {1}_{C} ( x - {x}_{i} ) .$$

Using these basis functions in the discrete formula in (27) gives a lumped-measure approximation of the indicator function over the primal grid. Note that both FV and FS schemes are constructed such that the d-measures of the solid over every subset of the d-cells (e.g., digitized areas in 2D and volumes in 3D) are captured exactly for the finite ∈>0, while other integral properties converge to their exact values as ∈→0⁺.

Using an FV scheme to approximate the indicator functions of stationary solids S₁⊆Ω₁ and Ω₂⊆Ω₂, the present disclosure obtain:

$${P}_{{S}_{1}}^{FV} ( x ) = {\sum }_{{i}_{1} = 1}^{{n}_{1}} {PS}_{1} , {i}_{1} 1 {c}_{{i}_{1}} ( x ) = {\sum }_{{i}_{1} = 1}^{{n}_{1}} {PS}_{1} , {i}_{1} {1}_{C} ( x - {x}_{{i}_{1}} ) ,$$

$${P}_{{S}_{2}}^{FV} ( x ) = {\sum }_{{i}_{2} = 1}^{{n}_{2}} {PS}_{2} , {i}_{2} 1 {c}_{{i}_{2}} ( x ) = {\sum }_{{i}_{1} = 1}^{{n}_{1}} {PS}_{2} , {i}_{2} {1}_{C} ( x - {x}_{{i}_{2}} ) ,$$

where PS₁, i₁, PS₂, i₂∈[0,1] are densities (e.g., d-measure fractions) of S₁∩Cᵢ_{₂}, respectively.

Using an FS scheme to approximate the indicator functions of relatively moving solids S_{1,2}(t)=T_{2,1}(t)S₁ and S_{2,1}(t)=T_{1,2}(t)S₂ defined above, the present disclosure obtain:

$$\begin{matrix}{ρ}_{{S}_{1 , 2} ( t )}^{FS} ( x ) = {ρ}_{{S}_{1}}^{FS} ( {τ}_{1 , 2} ( t ) x ) \\ = {ϵ}^{d} {\sum }_{{i}_{1} = 1}^{{n}_{1}} {ρ}_{{S}_{1} , {i}_{1}} {δ}^{d} ( {τ}_{1 , 2} ( t ) x - {x}_{{i}_{1}} )\end{matrix}$$

$$\begin{matrix}{ρ}_{{S}_{2 , 1} ( t )}^{FS} ( x ) = {ρ}_{{S}_{2}}^{FS} ( {τ}_{2 , 1} ( t ) x ) \\ = {ϵ}^{d} {\sum }_{{i}_{2} = 1}^{{n}_{2}} {ρ}_{{S}_{2} , {i}_{2}} {δ}^{d} ( {τ}_{2 , 1} ( t ) x - {x}_{{i}_{2}} )\end{matrix}$$

Substituting the indicator functions with their d-measure-preserving approximations via density functions, respectively, and rearranging sums and integrals, the following is obtained:

$$\begin{matrix}{g}_{{S}_{1}} \approx {\int }_{0}^{1} {\int }_{{Ω}_{1}} {ρ}_{{S}_{2 , 1} ( t )}^{FS} ( x ) {ρ}_{{S}_{1}}^{FV} ( x ) d {μ}^{d} [ x ] dt \\ = {\sum }_{{i}_{1} = 1}^{{n}_{1}} {\sum }_{{i}_{2} = 1}^{{n}_{2}} {ρ}_{{S}_{1} , {i}_{1}} {ρ}_{{S}_{2} , {i}_{2}} {w}_{{i}_{1} , {i}_{2}}^{1 , 2} ,\end{matrix}$$

$$\begin{matrix}{g}_{{S}_{2}} \approx {\int }_{0}^{1} {\int }_{{Ω}_{2}} {ρ}_{{S}_{1 , 2} ( t )}^{FS} ( x ) {ρ}_{{S}_{2}}^{FV} ( x ) d {μ}^{d} [ x ] dt \\ = {\sum }_{{i}_{1} = 1}^{{n}_{1}} {\sum }_{{i}_{2} = 1}^{{n}_{2}} {ρ}_{{S}_{1} , {i}_{1}} {ρ}_{{S}_{2} , {i}_{2}} {w}_{{i}_{2} , {i}_{1}}^{2 , 1} ,\end{matrix}$$

where the weights wᵢ_{₁}_{,i}_{₂}^{1,2} and wᵢ_{₂}_{,i}_{₁}^{2,1} are defined by:

$${w}_{{i}_{1} , {i}_{2}}^{1 , 2} {=}^{Δ} {ϵ}^{d} {\int }_{0}^{1} {\int }_{{Ω}_{1}} {δ}^{d} ( {τ}_{2 , 1} ( t ) x - {x}_{{i}_{2}} ) {1}_{{C}_{{i}_{1}}} ( x ) d {μ}^{d} [ x ] dt ,$$

$${w}_{{i}_{2} , {i}_{1}}^{2 , 1} {=}^{Δ} {ϵ}^{d} {\int }_{0}^{1} {\int }_{{Ω}_{2}} {δ}^{d} ( {τ}_{1 , 2} ( t ) x - {x}_{{i}_{1}} ) {1}_{{C}_{{i}_{2}}} ( x ) d {μ}^{d} [ x ] d t ,$$

The δ^{d}-function has a “sifting” property; meaning that it turns d-integrals into a reading of the integrand at the impulse centers (where the δ^{d}-function's input is zero):

$${w}_{{i}_{1} , {i}_{2}}^{1 , 2} = {ϵ}^{d} {\int }_{0}^{1} {1}_{{C}_{{i}_{1}}} ( {τ}_{1 , 2} ( t ) {x}_{{i}_{2}} ) d t$$

$${w}_{{i}_{2} , {i}_{1}}^{2 , 1} = {ϵ}^{d} {\int }_{0}^{1} {1}_{{C}_{{i}_{2}}} ( {τ}_{2 , 1} ( t ) {x}_{{i}_{1}} ) d t$$

Here is what these weights mean:
wᵢ_{₁}_{,i}_{₂}^{1,2} measures how long the grid vertex xᵢ_{₂}∈Ω₂ of the moving grid (attached to S₂⊆Ω₂) stays within the d-cell Cᵢ_{₁} under the motion T_{1,2}(t) for t∈[0,1].
wᵢ_{₂}_{,i}_{₁}^{2,1} measures how long the grid vertex xᵢ_{₁}∈Ω₁ of the moving grid (attached to S₁⊆Ω₁) stays within the d-cell Cᵢ_{₂} under the motion T_{2,1}(t) for t∈[0,1].

Due to the asymmetric nature, discretization strategy wᵢ_{₁}_{,i}_{₂}^{1,2}≠wᵢ_{₂}_{,i}_{₁}^{2,1}. Although both of them measure how long (in time) a give pair of vertices xᵢ_{₁}∈Ω₁ and xᵢ_{₂}∈Ω₂ of the two grids stay within an ϵ-neighborhood of one another under relative motion, their values are different because the neighborhoods are d-cubes oriented at different relative rotations. In other words, the two conditions in (42) and (43) are not equivalent:

The integrand in (40) is nonzero if T_{1,2}(t)xᵢ_{₂}∈Cᵢ_{₁}, e.g., (τ_{1,2}(t)xᵢ_{₂}−xᵢ_{₁})∈C, e.g.,

(τ₂(t)xᵢ_{₂}−τ₁(t)xᵢ_{₁})∈τ₁(t)C.

The integrand in (41) is nonzero if T_{2,1}(t)xᵢ_{₁}∈Cᵢ_{₂}, e.g., (τ_{2,1}(t)xᵢ_{₁}−xᵢ_{₂})∈C, e.g.,

(τ₁(t)xᵢ_{₁}−τ₂(t)xᵢ_{₂})∈τ₂(t)C.

The finite approximations of the collision measures can be written as matrix equations:

q_{S}_{₁}≈[ρ_{S}_{₁}_{,i}_{₁}]^{T}[wᵢ_{₁}_{,i}_{₂}^{1,2}][ρ_{S}_{₂}_{,i}_{₂}]

q_{S}_{₂}≈[ρ_{S}_{₂}_{,i}_{₂}]^{T}[wᵢ_{₂}_{,i}_{₁}^{2,1}][ρ_{S}_{₁}_{,i}_{₁}]

The two arrays [P_{S}_{₁}_{,i}_{₁}]n₁×1 and [P_{S}_{₂}_{,i}_{₂}]n₂×1 are discrete representations of the two solids, e.g., the design variables. Importantly, the two matrices [wᵢ_{₁}_{,i}_{₂}^{1,2}]n₁×n₂ and [wᵢ_{₂}_{,i}_{₁}^{2,1}]n₂×n₁ do not depend on the designs. The weights can be viewed as pairwise correlations between primal grid nodes of a moving grid and dual grid cells of a stationary grid, which depend solely on the relative motion of the grids and the grid structure (in this case, fully characterized by the resolution ∈>0). The matrices can thus be precomputed offline and reused in iterative design of the two solids. This property is critical for computational tractability of iterative design optimization, given that computing the collision measures for arbitrarily complex shapes and motions can be prohibitive in an iterative loop running hundreds or thousands of iterations.

To precompute the grid correlations (e.g., weights) in (40) and (41), the time integral can be discretized in using a simple Riemann sum approximation:

$${w}_{{i}_{1} , {i}_{2}}^{1 , 2} \approx {ϵ}^{d} δ {\sum }_{k = 1}^{K} {1}_{{C}_{{i}_{1}}} ( {τ}_{1 , 2} ( {t}_{k} ) {x}_{{i}_{2}} )$$

$${w}_{{i}_{2} , {i}_{1}}^{2 , 1} \approx {ϵ}^{d} δ {\sum }_{k = 1}^{K} {1}_{{C}_{{i}_{2}}} ( {τ}_{2 , 1} ( {t}_{k} ) {x}_{{i}_{1}} )$$

where tₖ≙(k−1)δ for k=1, 2, . . . , K to uniformly discretize the time period [0,1] with time-steps of δ=(K−1)⁻¹, small enough to capture the minimum features of the motion trajectories. Each sum takes 0 (K) operations involving evaluating and applying the motions T_{1,2}(tₖ)∈M_{1,2} and T_{2,1}(tₖ)∈M_{2,1} to each of the grid vertices xᵢ_{₁}∈Ω₁ and xᵢ_{₂}∈Ω₂, and testing the membership of the displaced points against Cᵢ_{₁} and Cᵢ_{₂}, respectively. For all time-steps and grid points, this takes O(n₁n₂K) operations, which is carried out once in a pre-processing step and can be perfectly parallelized on the CPU/GPU.

To enable co-design of [P_{S}_{₁}_{,i}_{₁}]n₁×1 and [P_{S}_{₂}_{,i}_{₂}]n₂×1 subject to collision avoidance constraints, the violation of such constraints (e.g., the collision measures) must be differentiated with respect to the design variables. The resulting discrete sensitivity fields associated with the respective grids are computed using a chain rule:

$$[ \frac{\partial {g}_{{S}_{1}}}{\partial {ρ}_{{i}_{1}}} ] \approx [ {w}_{{i}_{1} , {i}_{2}}^{1 , 2} ] [ {ρ}_{{S}_{2} , {i}_{2}} ] , [ \frac{\partial {g}_{{S}_{1}}}{\partial {ρ}_{{i}_{2}}} ] \approx {[ {w}_{{i}_{1} , {i}_{2}}^{1 , 2} ]}^{T} [ {ρ}_{{S}_{1} , {i}_{1}} ]$$

$$[ \frac{\partial {g}_{{S}_{2}}}{\partial {ρ}_{{i}_{1}}} ] \approx [ {w}_{{i}_{2} , {i}_{1}}^{2 , 1} ] [ {ρ}_{{S}_{1} , {i}_{1}} ] , [ \frac{\partial {g}_{{S}_{2}}}{\partial {ρ}_{{i}_{2}}} ] \approx {[ {w}_{{i}_{2} , {i}_{1}}^{2 , 1} ]}^{T} [ {ρ}_{{S}_{2} , {i}_{2}} ]$$

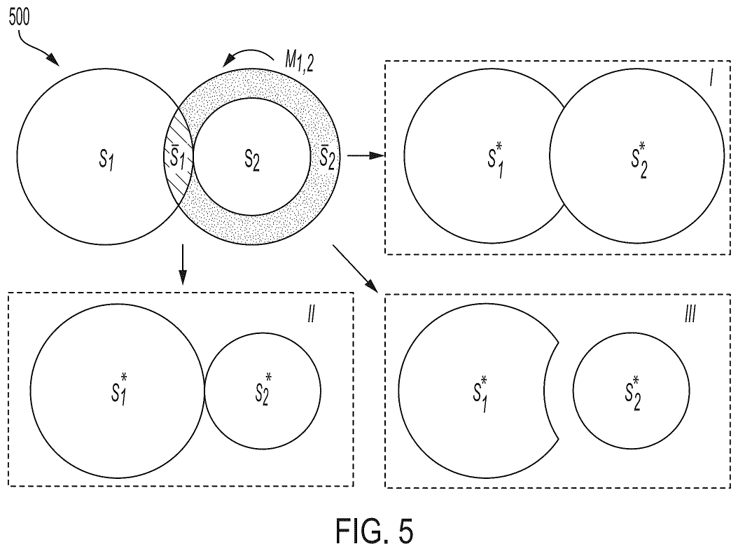

FIG. 5 illustrates an example 500 of generating collision minimizing shapes based on two initial designs, in accordance with aspects of the present disclosure. FIG. 5 illustrates aspects of the present disclosure regarding an optimization based formulation that allows both collision-free solids to evolve in a controlled manner, using the collision measures developed above. Using collision measures as constraints is not sufficient to define a well-posed optimization problem, because every subset of the maximal solids is also collision-free (despite not maximal). In practice, attempting to minimize the collision measures by gradient-descent optimization can lead to useless designs where the solids are excessively shrunk to avoid collision without maintaining contact.

FIG. 5 shows a stationary disk and a rotating disk around its center, and can satisfy collision avoidance with uncountably many solution, adding/removing material from either disk. However, only two of them (I and II) belong are maximal pairs while (III) is not. Therefore, additional constraints are needed to guarantee maximality.

First, partition the initial designs S₁⊆Ω₁ and S₂⊆Ω₂ are partitioned into two subdomains each; namely, the initially colliding subdomains [symbol] and [symbol] are:

Ŝ₁≙{x∈S₁| [symbol] _{S}_{₁}(x)>0}

Ŝ₂≙{x∈S₂| [symbol] _{S}_{₂}(x)>0}

The initially collision free subdomains [symbol] and [symbol] are:

[symbol]

≙{x∈S₁| [symbol] _{S}_{₁}(x)>0}

[symbol]

≙{x∈S₂| [symbol] _{S}_{₂}(x)>0}

S₁= [symbol] ∪ [symbol] and S₂= [symbol] ∪ [symbol] . The collisions by modifying the latter are to be eliminated. In an example, optimization problem may be posed to pick an objective function that pushes the collision avoidance constraints to become active, e.g., the resulting pairs of solids become maximally collision-free. The present disclosure observed that maximizing the d-measure of both design subdomains (e.g., area in 2D and volume in 3D) if effective in many scenarios—although more sophisticated objective functions such as contact and complementarity measures can be adopted in future work. Moreover, to control the choice of maximal pairs from a one-parametric family using a meaningful hyper-parameter γ∈[0,1], the present disclosure add another constraint that enforces a d-measure ratio between two solids. The optimization problem is thus formulated as finding [symbol] ⊆Ω₁ and [symbol] ⊆Ω₂ to:

$${Maximize}_{{\hat{S}}_{1} , \hat{{S}_{2}}} f ( {\hat{S}}_{1} , {\hat{S}}_{2} ) = {μ}^{d} [ {\hat{S}}_{1} ] + {μ}^{d} [ {\hat{S}}_{2} ]$$

$$subject to {q}_{{\hat{S}}_{1}} = 0$$

$${q}_{{\hat{S}}_{2}} = 0$$

$$g ( {\hat{S}}_{1} , {\hat{S}}_{2} ) = {γμ}^{d} [ {\hat{S}}_{1} ] - ( 1 - γ ) {μ}^{d} [ {\hat{S}}_{2} ] = 0$$

For gradient-descent optimization, the present disclosure defines a Lagrangian from the general formulation:

[symbol]

(Ŝ₁,Ŝ²)=f(Ŝ₁,Ŝ₂)+λ₁q̅_{Ŝ}_{₁}+λ₂q̅₂̅Ŝ₂+λ₃g(Ŝ₁,Ŝ₂)

Using the discretization scheme presented above, both [symbol] ⊆Ω₁ and [symbol] ⊆Ω₂ can be represented by density arrays [ [symbol] ]n₁×1, and [ [symbol] ]n₂×1, with pairwise collisions, [ŵᵢ_{₁}_{,i}_{₂}^{1,2}] and [ŵᵢ_{₂}_{,i}_{₁}^{2,1}] hence:

f(Ŝ₁,Ŝ₂)≈∈^{d}∥ρ_{Ŝ}_{₁}∥₁+∈^{d}∥ρ_{Ŝ}_{₂}∥₁

g(Ŝ₁,Ŝ₂)≈γ∈^{d}∥ρ_{Ŝ}_{₁}∥₁−(1−γ)∈^{d}∥ρ_{Ŝ}_{₂}∥₁

where ∥⋅∥₁ is the L₁-norm, e.g., ∥p_{Ŝ}_{₁}∥₁ and ∥p_{Ŝ}_{₂}∥₁ are sum of nonnegative density values in each array, approximating the d-measure of the solids they represent:

$${‖ {ρ}_{{\hat{S}}_{1}} ‖}_{1} {=}^{Δ} {\sum }_{{i}_{1} = 1}^{{n}_{1}} \vert {ρ}_{{\hat{S}}_{1} , {i}_{1}} \vert = {\sum }_{{i}_{1} = 1}^{{n}_{1}} {ρ}_{{\hat{S}}_{1} , {i}_{1}}$$

$${‖ {ρ}_{{\hat{S}}_{2}} ‖}_{1} {=}^{Δ} {\sum }_{{i}_{2} = 1}^{{n}_{2}} \vert {ρ}_{{\hat{S}}_{2} , {i}_{2}} \vert = {\sum }_{{i}_{2} = 1}^{{n}_{2}} {ρ}_{{\hat{S}}_{2} , {i}_{2}}$$

Without loss of generality, the present disclosure can eliminate ∈: =1 from all equations, given that aspects of the present disclosure is scale-agnostic. Substituting for the collision measures as well as the above norms, the following is obtained:

[symbol]

(Ŝ₁,Ŝ₂)≈(1+λ₃γ)∥ρ_{Ŝ}_{₁}∥₁+(1−λ₃(1−γ))∥ρ_{Ŝ}_{₂}∥₁

+λ₁[ρ_{Ŝ}_{₁}_{,i}_{₁}]^{T}[ŵᵢ_{₁}_{,i}_{₂}^{1,2}][ρ_{Ŝ}_{₂}_{,i}_{₂}]

+λ₂[ρ_{Ŝ}_{₂}_{,i}_{₂}]^{T}[ŵᵢ_{₂}_{,i}_{₁}^{2,1}][ρ_{Ŝ}_{₁}_{,i}_{₁}]

The quantities in the above Lagrangian and its partial derivatives with respect to design variables can be readily computed through linear-algebraic operations, which scale well for parallel computing on CPU/GPU, although the present disclosure have not implemented such parallelization in the present disclosure.

To solve the optimization problem an iterative approach is utilized where the method of moving asymptotes (MMA) is utilized. An example algorithm is provided below.

Algorithm Example
Co-generation of maximal collision-free solids

```
procedure Co-generation(S₁, S₂, M_{1,2}, M_{2,1}, γ)
Initialize [ρ_{S}_{₁}] ← [1_{S}_{₁}]
Initialize [ρ_{S}_{₂}] ← [1_{S}_{₂}]
Initialize Δ ← ∞
Initialize iter ← 0
([wᵢ_{₁}_{,i}_{₂}^{1,2}], [wᵢ_{₂}_{,i}_{₁}^{2,1}]) ← PrecompCo(S₁, S₂, M_{1,2}, M_{2,1})
([\hat{ρ}], ([ŵᵢ_{₁}_{,i}_{₂}^{1,2}], [ŵᵢ_{₂}_{,i}_{₁}^{2,1}]) ← ColVox([ρ], [wᵢ_{₁}_{,i}_{₂}^{1,2}], [wᵢ_{₂}_{,i}_{₁}^{2,1}])
while Δ > δ and iter < l do
    f ← Evaluate([\hat{ρ}]) [symbol]   Obj. func.
    $\frac{\partial {ℒ}_{[ \hat{ρ} ]}}{\partial \hat{ρ}} ← Gradient ( [ f , \hat{ρ} , [ {\hat{w}}_{{i}_{1} , {i}_{2}}^{1 , 2} ] , [ {\hat{w}}_{{i}_{2} , {i}_{1}}^{2 , 1} ] ) ⊳ Sens$
    $[ {\hat{ρ}}^{new} ] ← Update ( [ \hat{ρ} ] , \frac{\partial {ℒ}_{\hat{[ [ ]}}^{\partial }}{\partial \hat{ρ}} ) ⊳ Gradient Update$
    Δ ← Integrate([\hat{ρ}^{new} ] − [\hat{ρ}]) [symbol]   Vol. diff.
    iter ← iter +1 [symbol]   Iter. Counter
    [\hat{ρ}] ← [\hat{ρ}^{new} ] [symbol]   For next iteration
end while
return [\hat{p}]
end procedures
```

With the optimization formulated, various examples of co-generation of collision-free solids are provided below.

FIG. 6 illustrates local collision measures 600 for design domains for two rotating objects, in accordance with aspects of the present disclosure. As shown, the example 600 illustrates the above algorithm with two counter rotating squares where the angular position of the first square is provided by θ₁∈[0,2π) and the second square is θ₂∈[0,2π) where θ₁=−θ₂. The angular speed of each square is constant. The squares have dimensions and initial positions shown in FIG. 5. Additionally, the normalized local collision measure is provided in FIG. 5 to show how initially the two shapes collide. The temporal resolution is 500 time-steps and the squares each have a resolution of 400×400 voxels. As shown in FIG. 6, the two initial geometric representations, S₁ and S₂, for each design domain of the corresponding objects, rotate about respective centers with the same angular speed but in opposite directions. The local collision measure for each domain is shown in the bottom grey-scale plots.

FIG. 7 illustrates shape generation results of the rotating objects of FIG. 6, in accordance with aspects of the present disclosure. As shown, the co-generation procedure was applied for γ varying from 0 to 1 in 0.1 increments. Convergence plots are shown below for γ=0.4 and γ=0.5 to show demonstrate the convergence of. The convergence of summed d-measures of the two collision-free solids for γ=0.4 (the sub FIG. 710 on the left) and γ=0.5 (the sub FIG. 720 on the right).

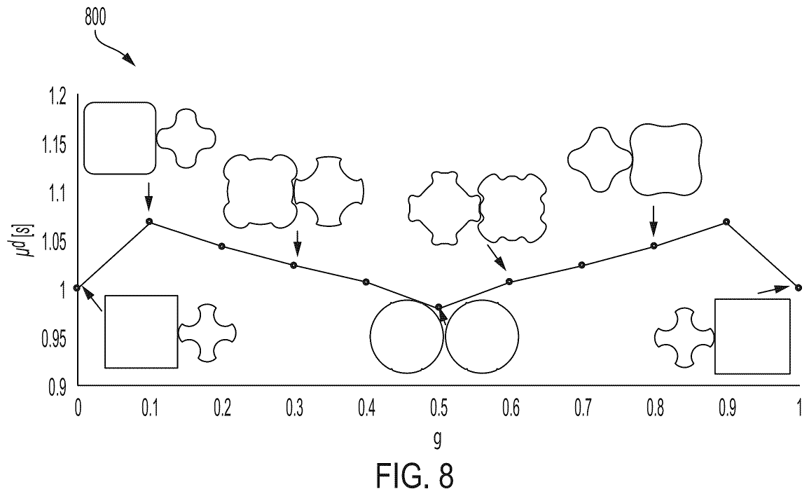

FIG. 8 illustrates example shape generation results 800 as a function of a hyper-parameter of the rotating objects of FIG. 6, in accordance with aspects of the present disclosure. As shown, FIG. 8 provides a plot of the sum of the d measure of each co-generated solid as a function of γ. Selected solutions co-generated by the procedure are included as well. All solids shown are subject to thresholds for [p_{S}_{₁}_{,i}_{₁}, [p_{S}_{₂}_{,i}_{₂}]>0.5. Due to the symmetry of the trajectories and domains, the total weighted area as a function of γ is symmetric about γ=0.5. The solids also reflect this symmetry. Additionally, the results of γ=0 and γ=1 precisely match the results that would be obtained if the unsweep operation were performed.

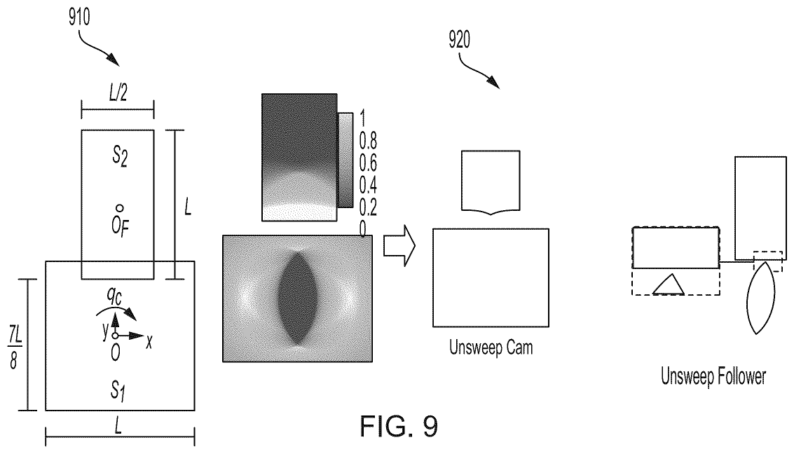

FIG. 9 illustrates examples of local collision measure and unsweep operation on a cam-follower mechanism 910, in accordance with aspects of the present disclosure. As shown, the cam, which is initially a square of length L, is prescribed to rotate 2π radians about its center, which is the origin O of the space, while the follower moves in the vertical direction as a function of the angular position of the cam, θ_{C}. The vertical position y_{F} of the center of the follower, as a function of θ_{C} provided by the following formula:

$${y}_{F} = \frac{3 L}{4} + \frac{L}{8} cos ( 2 {θ}_{C} ) .$$

As shown on the left, dimensions and initial positions of the cam and follower are provided. The normalized local collision measures are provided to show how initially the two shapes collide. The plots of local collisions measures are offset and rescaled for clarity and do not correspond to the initial physical locations. The local collision measure for each domain is shown in the grey-scale representations.

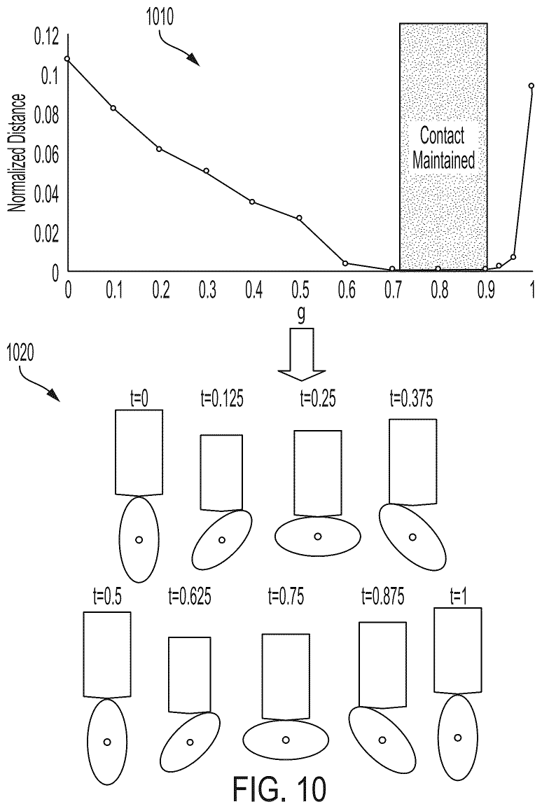

As shown on the right, the results 920 illustrates how the unsweep operation can result in a loss of contact for the cam and follower. The temporal resolution is 1,000 time-steps, the resolution of the cam is 400×400, and the resolution of the follower is 400×200. The unsweep operations result in a loss of contact at certain times in the trajectory. This example therefore shows that co-generation (shown in FIG. 10) is necessary to enable continuous contact between the domains to ensure functionality.

FIG. 10 illustrates examples of shape co-generation results for maintaining contact during motion of the cam-follower mechanism of FIG. 9, in accordance with aspects of the present disclosure. In the illustrated examples, the co-generation procedure was applied for γ varying from 0 to 1 in 0.1 increments. FIG. 10 provides a plot of the average minimum distance between the two solutions as they move through their trajectories as a function of γ. As discussed, certain γ values result in a loss of contact and therefore would not be functional.

In the range of approximately γ∈(0.7, 0.9) the solutions maintains contact even though it is not an explicit constraint. The present disclosure may not guarantee a continuous contact, for example, continuous contact is not required as maximality in collision avoidance may imply contact in one configuration, but not persistent contact throughout the whole motion, as shown in the results of FIG. 10. The point is to demonstrate that co-generation is a necessary approach to create functional parts. Future work will focus on ensuring persistent contact. As shown, the average distance between cam and follower as a function of γ which illustrates co-generation is necessary to maintain contact during motion. As shown in the plot 1010 of FIG. 10, contacts are maintained when γ=0.8. The corresponding geometric representation results (over time) are shown in the examples 1020.

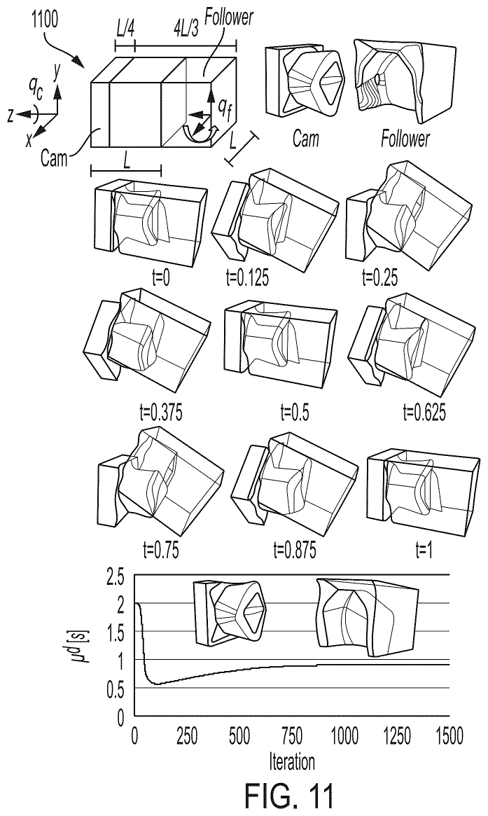

FIG. 11 illustrates examples 1100 of co-generation of shapes of a three-dimensional (3D) cam-follower mechanism, in accordance with aspects of the present disclosure. This example illustrates a spherical cam that rotates about the z-axis by an angle θ_{C} at constant angular velocity. Simultaneously the follower rotates about the x-axis with the angular position, θ_{F}. The rotation matrices describing the motion of the cam and follower, R_{C} and R_{C} are provided below:

$${R}_{C} = [ \begin{matrix}cos ( {θ}_{C} ) & sin ( {θ}_{C} ) & 0 \\ - sin ( {θ}_{C} ) & cos ( {θ}_{C} ) & 0 \\ 0 & 0 & 1\end{matrix} ] ,$$

$${R}_{F} = [ \begin{matrix}1 & 0 & 0 \\ 0 & cos ( {θ}_{F} ) & sin ( {θ}_{F} ) \\ 0 & - sin ( {θ}_{F} ) & cos ( {θ}_{F} )\end{matrix} ] ,$$

where θ_{F}−½ |sin(θ_{C})|.

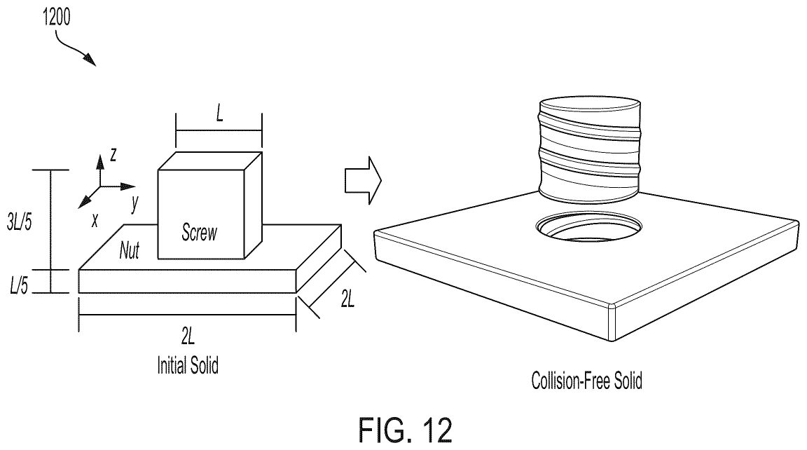

The dimensions and initial positions are provided in the upper left corner of FIG. 11. The temporal resolution is 5,000 time-steps, the resolution of the cam is 105×105×105, and the resolution of the follower is 105×105×140. Each domain has greater than a million voxels. Similar to the 2D cam/follower system, if the unsweep operation was used to generate the collision-free shapes, a loss of contact would occur. By co-generating the solids, on the other hand, contact can be maintained as shown in FIG. 12 where the cam and follower are in various positions during the trajectory when γ=0.5. In addition, a convergence plot is provided for γ=0.5 at the bottom of FIG. 11, which shows the convergence of summed d-measures of the two collision free solids for γ=0.5.

FIG. 12 illustrates an example 1200 of co-generation of shapes of a collision-free nut-screw coupling, in accordance with aspects of the present disclosure. As shown, given the dimensions and initial positions provided on the left, the motion of the screw is defined by:

$${R}_{screw} = [ \begin{matrix}cos ( 4 ϕ ) & sin ( 4 ϕ ) & 0 & 0 \\ - sin ( 4 ϕ ) & cos ( 4 ϕ ) & 0 & 0 \\ 0 & 0 & 1 & \frac{- 2 L}{5 π} ϕ \\ 1 & 1 & 1 & 1\end{matrix} ] ,$$

where ϕ_{S} is the rotation of the screw about the z-axis and the nut is stationary, and where R_{S} describes the motion of the screw in the homogeneous transformation matrix, and the screw is translating about the z-axis as a function of its rotation, ϕ∈[0, 2π]. During its movement, the screw rotates 4 times. The temporal resolution is 5,000 time-steps, the resolution of the screw is 50×50×150, and the resolution of the nut is 100×100×50. One particular solution in which γ=0.2 is provided on the right of FIG. 12.

As shown, the automatic co-generation of threads and convergence to a screw and nut pair, starting from two colliding boxes, illustrates aspects of the present disclosure. The threads appear naturally to generate maximal collision-free pairs from a screw motion, leading to a screw and nut pair with the same pitch as the given screw motion. The screw and nut pair need not be the only optimal solutions for such a motion path, however, as a cylindrical peg and hole pair would satisfy all the constraints, including maximally collision-free persistent contact, maximal (space-filling) mass, and desired mass ratio.

There may be infinitely many screw and nut pairs (of different thread profiles) that could satisfy the constraints and have equal (maximal) mass, thus automatically generating geometric representations of one of these threaded solids is more likely than finding the degenerate extreme case of cylindrical peg and hole (e.g., no threads). As such, aspects of the present disclosure employ methods that lead to convergence to one such local extremum of the optimization problem. Without the need to co-generate all possible shapes for the object pairs, additional constraints or an entirely different objective functions or constraints, e.g., maximizing contact, or complementarity measures as opposed to total mass and mass ratio (as well as manufacturing constraints and material considerations), may be used to identify more maximal pairs with better form, fit, or function.

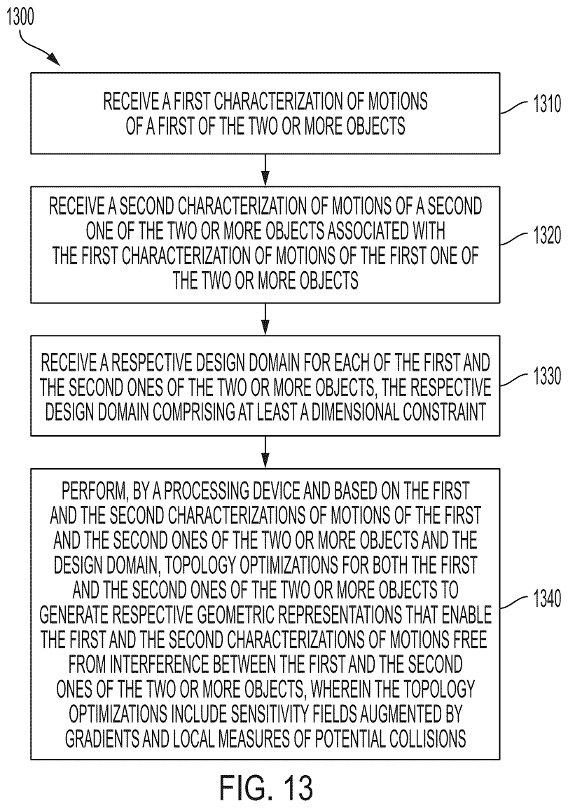

FIG. 13 illustrates a flow diagram of methods of operations 1300, in accordance with aspects of the present disclosure. For example, the operations 1300 may correspond to the operations by the collision-free shape co-generation module 220 described with reference to FIG. 2. The operations 1300 may be performed by a processing device, such as the collision-free shapes co-generation processing device 160 as described with reference to FIG. 1.

The operations 1300 begins at 1310, by receiving a first characterization of motions of a first one of the two or more objects.

At 1320, a second characterization of motions of a second one of the two or more objects is received. The second characterization of motions is associated with the first characterization of motions of the first one of the two or more objects.

At 1330, a respective design domain for each of the first and the second ones of the two or more objects is received. The respective design domain includes at least a dimensional constraint for the two or more objects.

At 1340, a processing device performs, based on the first and the second characterizations of motions of the first and the second ones of the two or more objects and the design domain, topology optimizations for both the first and the second ones of the two or more objects to generate respective geometric representations that enable the first and the second characterizations of motions free from interference between the first and the second ones of the two or more objects. The topology optimizations include sensitivity fields augmented by gradients and local measures of potential collisions. In some cases, the processing device is coupled to a memory in an apparatus to carry out the operations.

In aspects, the processing device may perform the topology optimizations for both the first and the second ones of the two or more objects to generate the respective geometric representations by: performing an unsweep operation in the respective design domain for each of the first and the second ones of the two or more objects; and measuring potential collisions of solids, based on the first and the second characterizations of motions, locally and globally for a gradient-descent optimization.

In aspects, the processing device may perform the topology optimizations for both the first and the second ones of the two or more objects to generate the respective geometric representations further by: generating the respective geometric representations in an incremental or iterative procedure for a subset of maximal pairs of collision-free solids corresponding to the first and the second ones of the two or more objects, wherein the subset of maximal pairs of collision-free solids are conditioned upon an increase of shape in either the first or the second one of the one or more objects causes a collision.

In some cases, the first and the second characterizations of motions may include at least one of: a trajectory or a boundary of motions; a velocity of movements along the trajectory or within the boundary; a rate of rotation along the trajectory or within the boundary; or a causal relationship between the first characterization of motions and the second characterization of motions.

In aspects, the respective design domain further includes at least one of: a parameter of a material aspect of the first or the second one of the one or more objects for determining deformation in the potential collisions; or a parameter of a production aspect of the first or the second one of the one or more objects for determining manufacturability of the first or the second one of the one or more objects.

In some cases, the geometric representations of the first and the second ones of the one or more objects maintain a profile of contact in or during the first and the second characterizations of motions.

In some cases, the respective geometric representations comprise shapes that are: specific to one or more materials to be used, and specific to manufacturing techniques for the one or more materials to be used, wherein the shapes are represented by data convertible to additive manufacturing instructions.

Various operations are described as multiple discrete operations, in turn, in a manner that is most helpful in understanding the present disclosure, however, the order of description may not be construed to imply that these operations are necessarily order dependent. In particular, these operations need not be performed in the order of presentation.

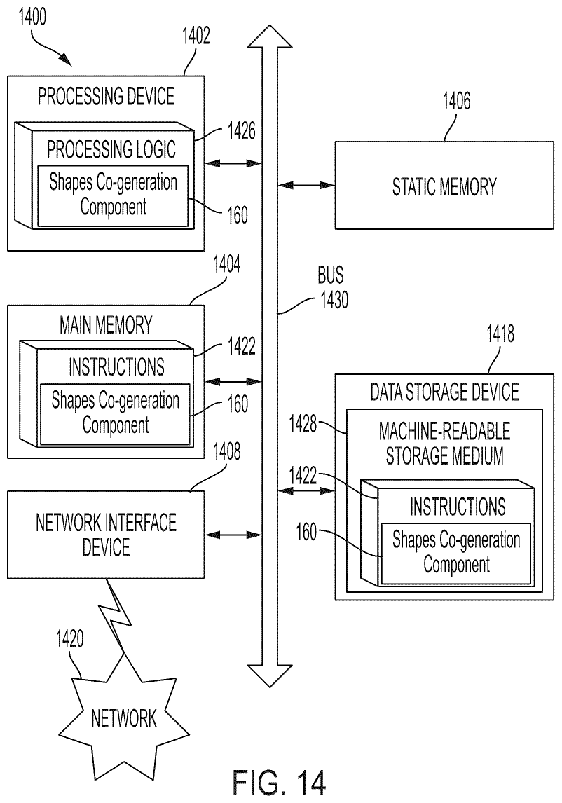

FIG. 14 illustrates a diagrammatic representation of a machine in the example form of a computer system 1400 within which a set of instructions 1422, for causing the machine to perform any one or more of the methodologies discussed herein (such as the operations 1300), may be executed. In various embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 1400 may be representative of a server computer system, such as system 100.

The exemplary computer system 1400 includes a processing device 1402, a main memory 1404 (e.g., read-only memory (ROM), flash memory, dynamic random access memory (DRAM), a static memory 1406 (e.g., flash memory, static random access memory (SRAM), etc.), and a data storage device 1418, which communicate with each other via a bus 1430. The processing device 1402 may be implemented as the shape co-generation component 160 or a related processing device unit. In some cases, the processing device 1402 may be used to perform tasks associated with the shape co-generation component 160. Any of the signals provided over various buses described herein may be time multiplexed with other signals and provided over one or more common buses. Additionally, the inter1429 connection between circuit components or blocks may be shown as buses or as single signal lines. Each of the buses may alternatively be one or more single signal lines and each of the single signal lines may alternatively be buses.

Processing device 1402 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1402 may also be one or more special-purpose processing devices such as an application specific integrated circuit (ASIC), a field programmable gate array (FPGA), a digital signal processor (DSP), network processor, or the like. The processing device 1402 may execute processing logic 1426, which may be one example of system 100 shown in FIG. 1, for performing the operations and steps discussed herein.

The data storage device 1418 may include a machine-readable storage medium 1428, on which is stored one or more set of instructions 1422 (e.g., software) embodying any one or more of the methodologies of functions described herein, including instructions to cause the processing device 1402 to execute system 100. The instructions 1422 may also reside, completely or at least partially, within the main memory 1404 or within the processing device 1402 during execution thereof by the computer system 1400; the main memory 1404 and the processing device 1402 also constituting machine-readable storage media. The instructions 1422 may further be transmitted or received over a network 1420 via the network interface device 1408.

The non-transitory machine-readable storage medium 1428 may also be used to store instructions to perform the methods and operations described herein. While the machine-readable storage medium 1428 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass embodiments in hardware, software, or a combination thereof

What is claimed is:

1. A method for generating geometric representations to be manufactured for two or more objects interacting with each other, the method comprising:
receiving a first characterization of motions of a first one of the two or more objects;
receiving a second characterization of motions of a second one of the two or more objects associated with the first characterization of motions of the first one of the two or more objects;
receiving a respective design domain for each of the first and the second ones of the two or more objects, the respective design domain comprising at least a dimensional constraint; and
performing, by a processing device and based on the first and the second characterizations of motions of the first and the second ones of the two or more objects and the design domain, topology optimizations for both the first and the second ones of the two or more objects to generate respective geometric representations that enable the first and the second characterizations of motions free from interference between the first and the second ones of the two or more objects, wherein the topology optimizations include sensitivity fields augmented by gradients and local measures of potential collisions.

2. The method of claim 1, wherein performing the topology optimizations for both the first and the second ones of the two or more objects to generate the respective geometric representations comprises:
performing an unsweep operation in the respective design domain for each of the first and the second ones of the two or more objects; and
measuring potential collisions of solids, based on the first and the second characterizations of motions, locally and globally for a gradient-descent optimization.

3. The method of claim 2, wherein performing the topology optimizations for both the first and the second ones of the two or more objects to generate the respective geometric representations further comprises:
generating the respective geometric representations in an incremental or iterative procedure for a subset of maximal pairs of collision-free solids corresponding to the first and the second ones of the two or more objects, wherein the subset of maximal pairs of collision-free solids are conditioned upon an increase of shape in either the first or the second one of the one or more objects causes a collision.

4. The method of claim 1, wherein the first and the second characterizations of motions comprises at least one of:
a trajectory or a boundary of motions;
a velocity of movements along the trajectory or within the boundary;
a rate of rotation along the trajectory or within the boundary; or
a causal relationship between the first characterization of motions and the second characterization of motions.

5. The method of claim 1, wherein the respective design domain further comprises at least one of:
a parameter of a material aspect of the first or the second one of the one or more objects for determining deformation in the potential collisions; or
a parameter of a production aspect of the first or the second one of the one or more objects for determining manufacturability of the first or the second one of the one or more objects.

6. The method of claim 1, wherein the geometric representations of the first and the second ones of the one or more objects maintain a profile of contact in or during the first and the second characterizations of motions.

7. The method of claim 1, wherein the respective geometric representations comprise shapes that are:
specific to one or more materials to be used, and
specific to manufacturing techniques for the one or more materials to be used, wherein the shapes are represented by data convertible to additive manufacturing instructions.

8. An apparatus for generating geometric representations to be manufactured for two or more objects interacting with each other, the apparatus comprising:
a memory;
a processing device operatively coupled to the memory, the processing device and the memory configured to:
receive a first characterization of motions of a first one of the two or more objects;
receive a second characterization of motions of a second one of the two or more objects associated with the first characterization of motions of the first one of the two or more objects;
receive a respective design domain for each of the first and the second ones of the two or more objects, the respective design domain comprising at least a dimensional constraint; and
perform, by a processing device and based on the first and the second characterizations of motions of the first and the second ones of the two or more objects and the design domain, topology optimizations for both the first and the second ones of the two or more objects to generate respective geometric representations that enable the first and the second characterizations of motions free from interference between the first and the second ones of the two or more objects, wherein the topology optimizations include sensitivity fields augmented by gradients and local measures of potential collisions.

9. The apparatus of claim 8, wherein the processing device and the memory are configured to perform the topology optimizations for both the first and the second ones of the two or more objects to generate the respective geometric representations by:
performing an unsweep operation in the respective design domain for each of the first and the second ones of the two or more objects; and
measuring potential collisions of solids, based on the first and the second characterizations of motions, locally and globally for a gradient-descent optimization.

10. The apparatus of claim 9, wherein the processing device and the memory are configured to perform the topology optimizations for both the first and the second ones of the two or more objects to generate the respective geometric representations further by:
generating the respective geometric representations in an incremental or iterative procedure for a subset of maximal pairs of collision-free solids corresponding to the first and the second ones of the two or more objects, wherein the subset of maximal pairs of collision-free solids are conditioned upon an increase of shape in either the first or the second one of the one or more objects causes a collision.

11. The apparatus of claim 8, wherein the first and the second characterizations of motions comprises at least one of:
a trajectory or a boundary of motions;
a velocity of movements along the trajectory or within the boundary;
a rate of rotation along the trajectory or within the boundary; or
a causal relationship between the first characterization of motions and the second characterization of motions.

12. The apparatus of claim 8, wherein the respective design domain further comprises at least one of:
a parameter of a material aspect of the first or the second one of the one or more objects for determining deformation in the potential collisions; or
a parameter of a production aspect of the first or the second one of the one or more objects for determining manufacturability of the first or the second one of the one or more objects.

13. The apparatus of claim 8, wherein the geometric representations of the first and the second ones of the one or more objects maintain a profile of contact in or during the first and the second characterizations of motions.

14. The apparatus of claim 8, wherein the respective geometric representations comprise shapes that are:
specific to one or more materials to be used, and
specific to manufacturing techniques for the one or more materials to be used, wherein the shapes are represented by data convertible to additive manufacturing instructions.

15. A non-transitory computer-readable storage medium having instructions stored thereon that, when executed by a processing device for generating geometric representations to be manufactured for two or more objects interacting with each other, cause the processing device to:
receive a first characterization of motions of a first one of the two or more objects;
receive a second characterization of motions of a second one of the two or more objects associated with the first characterization of motions of the first one of the two or more objects;
receive a respective design domain for each of the first and the second ones of the two or more objects, the respective design domain comprising at least a dimensional constraint; and
perform, by a processing device and based on the first and the second characterizations of motions of the first and the second ones of the two or more objects and the design domain, topology optimizations for both the first and the second ones of the two or more objects to generate respective geometric representations that enable the first and the second characterizations of motions free from interference between the first and the second ones of the two or more objects, wherein the topology optimizations include sensitivity fields augmented by gradients and local measures of potential collisions.

16. The non-transitory computer-readable storage medium of claim 15, further comprising instructions to cause the processing device to perform the topology optimizations for both the first and the second ones of the two or more objects to generate the respective geometric representations by:
performing an unsweep operation in the respective design domain for each of the first and the second ones of the two or more objects; and
measuring potential collisions of solids, based on the first and the second characterizations of motions, locally and globally for a gradient-descent optimization.

17. The non-transitory computer-readable storage medium of claim 16, further comprising instructions to cause the processing device to perform the topology optimizations for both the first and the second ones of the two or more objects to generate the respective geometric representations further by:
generating the respective geometric representations in an incremental or iterative procedure for a subset of maximal pairs of collision-free solids corresponding to the first and the second ones of the two or more objects, wherein the subset of maximal pairs of collision-free solids are conditioned upon an increase of shape in either the first or the second one of the one or more objects causes a collision.

18. The non-transitory computer-readable storage medium of claim 15, wherein the first and the second characterizations of motions comprises at least one of:
a trajectory or a boundary of motions;
a velocity of movements along the trajectory or within the boundary;
a rate of rotation along the trajectory or within the boundary; or
a causal relationship between the first characterization of motions and the second characterization of motions.

19. The non-transitory computer-readable storage medium of claim 15, wherein the respective design domain further comprises at least one of:
a parameter of a material aspect of the first or the second one of the one or more objects for determining deformation in the potential collisions; or
a parameter of a production aspect of the first or the second one of the one or more objects for determining manufacturability of the first or the second one of the one or more objects.

20. The non-transitory computer-readable storage medium of claim 15, wherein the geometric representations of the first and the second ones of the one or more objects maintain a profile of contact in or during the first and the second characterizations of motions.
